(19) United States
(12) Patent Application Publication
(10) Pub. No.: US 2008/0097804 A1
(43) Pub. Date: Apr. 24, 2008

(54) SYSTEM AND METHOD FOR DEVELOPING AND MANAGING A MANUFACTURING PROCESS

(76) Inventor: Richard A. Soltero, Holly Springs, NC (US)

Correspondence Address: MOORE & VAN ALLEN PLLC, P.O. BOX 13706, Research Triangle Park, NC, 27709, US

(21) Appl. No.: 11/860,836

(22) Filed: Sep. 25, 2007

Related U.S. Application Data
(60) Provisional application No. 60/848,714, filed on Oct. 2, 2006.
(60) Provisional application No. 60/940,499, filed on May 29, 2007.

(51) Int. Cl. G06Q 10/00

(52) U.S. Cl. 705/7

(57) ABSTRACT

A method for developing and managing a manufacturing process may include presenting a graphical user interface to define a project for developing and managing the manufacturing process for a product and storing the data entered to define the project in a database. The method may also include presenting a graphical user interface to at least one process development participant for entering data related to developing and managing the manufacturing process and storing the data related to developing and managing the manufacturing process in the database. The method may further include presenting selected data related to developing and managing the manufacturing process. In accordance with another embodiment of the present invention, a quality assurance system may be associated with the manufacturing process. The method may also include developing and managing the manufacturing process and the quality assurance system which may be integrated in the manufacturing process.

### CROSS-REFERENCE TO RELATED APPLICATIONS

This application claims benefit of priority under 35 U.S.C. § 119(e) to the filing date of U.S. Provisional Application 60/848,714, filed on Oct. 2, 2006, and U.S. Provisional Application 60/940,499 filed on May 29, 2007 which are incorporated herein by reference in their entirety.

### COPYRIGHT NOTICE

A portion of the disclosure of this patent document contains material that is subject to copyright protection. The copyright owner has no objection to the facsimile reproduction by anyone of the patent document, or the patent disclosure, as it appears in the Patent and Trademark Office patent files or records, but otherwise reserves all copyright rights whatsoever.

### BACKGROUND OF THE INVENTION

The present invention relates to managing quality assurance information and manufacturing processes, and more particularly to a method for managing manufacturing processes that are integrated with quality systems, such as a manufacturing process for active pharmaceutical ingredients, pharmaceutical drug products or other biomedical products.

There exists a need in the Federal Drug Administration (FDA)-regulated Clinical Trials process to manufacture new drug product in limited quantities with specific formulations and delivery methods in order to conduct defined trials. There also exists a need in the Federal Drug Administration (FDA)-regulated commercial process to manufacture drug product in small scale quantities with specific formulations and delivery methods in order to meet market demand. In the past, pharmaceutical companies with large drug pipelines have had the financial means and need to fund full-time manufacturing facilities and associated staff, and to develop specific protocols associated with Good Manufacturing Processes (GMP) at the manufacturing site. These sites have employed a number of software applications within the facility to assist in various aspects of production, such as project management, inventory management, material specification, and workflow.

In recent years, the landscape for creation of new drug products has dramatically changed, as many pharmaceutical and biotechnology companies have come into existence to develop only one or a few products. These small companies have a need to create new drug product, but lack the ability to fund proprietary manufacturing projects. Thus, a niche for the capability to address one specific drug-product manufacturing requirement with appropriate scaling capabilities, limited and geographically dispersed staff, prescribed standards, and a uniform process that can be accessed remotely and that comprehensively addresses all GMP management and manufacturing needs becomes paramount to success. The invention presented in this patent application addresses that need.

### BRIEF SUMMARY OF THE INVENTION

In accordance with an embodiment of the present invention, a method for developing and managing a manufacturing process may include presenting a graphical user interface to initiate a manufacturing project, to import or input data, information and specifications related to the manufacturing project, and for developing and managing the manufacturing process for a product. The method may also include storing the data entered to define the project in a database. The method may also include presenting a graphical user interface to at least one process development participant for entering data related to developing and managing the manufacturing process and storing the data related to developing and managing the manufacturing process in the database. The method may further include presenting selected data related to developing and managing the manufacturing process.

In accordance with another embodiment of the present invention, the method may further include developing and managing the manufacturing process and quality system. The quality system may be integrated with the manufacturing process. Standard operating procedures may also be incorporated or integrated into the system. The graphical user interface may include features to import or input data, information and specifications for equipment, manufacturing rooms, methods, materials, parts, products and any other data or information related to the manufacturing process and the quality system.

In accordance with another embodiment of the present invention, a method for developing and managing a manufacturing process may include enabling a project to be defined or initiated for developing and managing the manufacturing process and/or quality management system for a product and storing the data entered to define the project in a database. The method may also include enabling a plurality of geographically disperse process development participants to enter data related to developing and managing the manufacturing process and/or quality management system and storing the data related to developing and managing the manufacturing process and/or quality management system in the database. The method may further include presenting selected data related to developing and managing the manufacturing process and/or quality management system in response to a query.

In accordance with an embodiment of the present invention, a system for developing and managing a manufacturing process may include a processor and a manufacturing management module operable on the processor. The manufacturing management module may include a capability of presenting a graphical user interface to define a project for developing and managing the manufacturing process for a product. The manufacturing management module may also include a capability of presenting a graphical user interface to at least one process development participant for entering data related to developing and managing the manufacturing process. The manufacturing management module may further include a capability of presenting selected data related to developing and managing the manufacturing process. The system may also include developing and managing the manufacturing process with a quality system that may be integrated with the manufacturing process and may include standard operating procedures.

In accordance with another embodiment of the present invention, a computer program product for developing and managing a manufacturing process may include a computer usable medium having computer usable program code embodied therein. The computer usable medium may include computer usable program code configured to enable a project to be defined for developing and managing the manufacturing process for a product. The computer usable medium may also include computer usable program code configured to store the data entered to define the project in a database. The computer useable medium may also include computer usable program code configured to enable a plurality of geographically disperse process development participants to enter data related to developing and managing the manufacturing process. The computer useable medium may also include computer usable program code configured to store the data related to developing and managing the manufacturing process in the database. The computer useable medium may further include computer usable program code configured to present selected data related to developing and managing the manufacturing process in response to a query. The computer useable medium may further include computer usable program code configured to develop and manage a manufacturing process and a quality system that may be integrated with the manufacturing process.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a block schematic diagram of an example of a system for managing a manufacturing process with an integrated quality system, such as a clinical trials manufacturing process, in accordance with an embodiment of the present invention.

FIG. 2 is a flow chart of an example of a method for managing a manufacturing process, such as a clinical trials manufacturing process, in accordance with an embodiment of the present invention.

FIGS. 3A and 3B (collectively FIG. 3) is a flow chart of an example of a method for managing a manufacturing process, such as a clinical trials manufacturing process, in accordance with another embodiment of the present invention.

FIG. 4 is a flow chart of an example of a method for developing and managing a manufacturing process, such as a clinical trials manufacturing process, using multiple geographically disperse participants in accordance with an embodiment of the present invention.

FIG. 5 is a block schematic diagram of an example of a system for developing and managing a manufacturing process, such as a clinical trials manufacturing process, using multiple geographically disperse participants in accordance with an embodiment of the present invention.

FIG. 6 is an example of a GUI to facilitate entering and managing personnel associated with developing and managing a manufacturing process in accordance with an embodiment of the present invention.

FIG. 7 is an example of a GUI to facilitate entering and managing project sponsors associated with developing and managing a manufacturing process in accordance with an embodiment of the present invention.

FIG. 8 is an example of a GUI to define a project associated with developing and managing a manufacturing process in accordance with an embodiment of the present invention.

FIG. 9 is an example of a GUI to assign personnel to a project associated with developing and managing a manufacturing process in accordance with an embodiment of the present invention.

FIG. 10 is an example of a GUI to enter and record vendor information associated with developing and managing a manufacturing process in accordance with an embodiment of the present invention.

FIG. 11 is an example of a GUI to enter and record information related to materials associated with a product to be manufactured by the process being developed in accordance with an embodiment of the present invention.

FIG. 12 is an example of a GUI to enter and record different material types for manufacturing the product in accordance with an embodiment of the present invention.

FIG. 13 is an example of a GUI to enter and record different material statuses in accordance with an embodiment of the present invention.

FIG. 14 is an example of a GUI to enter and record different types of packaging in accordance with an embodiment of the present invention.

FIG. 15 is an example of a GUI to enter and record different storage conditions in accordance with an embodiment of the present invention.

FIG. 16 is an example of a GUI to enter and record equipment information associated with a manufacturing process in accordance with an embodiment of the present invention.

FIG. 17 is an example of a GUI to enter and record room information associated with managing a manufacturing process in accordance with an embodiment of the present invention.

FIG. 18 is an example of a GUI to enter and record test information or different types of tests associated with managing a manufacturing process in accordance with an embodiment of the present invention.

FIG. 19 is an example of a GUI to enter and record method information or different types of methods associated with managing a manufacturing process in accordance with an embodiment of the present invention.

FIG. 20 is an example of a GUI to enter a query associated with managing a manufacturing process, such as a clinical trials manufacturing process, in accordance with an embodiment of the present invention.

FIG. 21 is an example of a GUI to enter and record equipment information associated with a manufacturing process in accordance with an embodiment of the present invention.

FIG. 22 is an example of a GUI to enter and record room information associated with a manufacturing process in accordance with an embodiment of the present invention.

FIG. 23 is an example of a GUI to enter and record specifications related to materials associated with a product to be made by the manufacturing process in accordance with an embodiment of the present invention.

FIG. 24 is an example of a GUI to enter and record specifications related to a material specification test review in accordance with an embodiment of the present invention.

FIG. 25 is an example of a GUI to enter and record information related to a Build Requisition or elements needed to make a product in accordance with an embodiment of the present invention.

FIG. 26 is an example of a GUI of an exemplary Requisition Review form associated with a manufacturing process in accordance with an embodiment of the present invention.

FIG. 27 is an example of a GUI of an exemplary Inventory Receipt form associated with a manufacturing process in accordance with an embodiment of the present invention.

FIG. 28 is an example of a GUI of an exemplary Inventory Status form associated with a manufacturing process in accordance with an embodiment of the present invention.

FIG. 29 is an example of a GUI of an exemplary Inventory Use form associated with a manufacturing process in accordance with an embodiment of the present invention.

FIG. 30 is an example of a GUI of an exemplary Inventory Depleted form associated with a manufacturing process in accordance with an embodiment of the present invention.

FIG. 31 is an example of a GUI of an exemplary Master Production Record (MPR) associated with a manufacturing process in accordance with an embodiment of the present invention.

FIG. 32 is an example of a GUI responsive to a Bill of Materials tab and an Equipment tab of a MPR being selected in accordance with an embodiment of the present invention.

FIG. 33 is an example of a GUI responsive to a Bill of Materials tab and a Material tab of a MPR being selected in accordance with an embodiment of the present invention.

FIG. 34 is an example of a GUI responsive to a General Info tab and a MPR Approvals tab of a MPR being selected in accordance with an embodiment of the present invention.

FIG. 35 is an example of a GUI responsive to a General Info tab and an In Process Test tab of a MPR being selected in accordance with an embodiment of the present invention.

FIG. 36 is an example of a GUI of an exemplary MPR Manufacturing Instructions form in accordance with an embodiment of the present invention.

FIG. 37 is an example of a GUI of an exemplary Batch Production Record (BPR) associated with a manufacturing process in accordance with an embodiment of the present invention.

FIG. 38 is an example of a GUI of an exemplary Batch Production Record (BPR) associated with a manufacturing process in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

The present invention provides methods and systems for managing information related to a drug product and/or formulation for a clinical trial. The system incorporates information relating to prescribed standards, such as Good Manufacturing Practices, and includes safeguards designed to ensure that manufacture is in accordance with those prescribed standards. Based on information input into the system, the system may output Standard Operating Procedure documentation, instructions for site preparation and drug manufacturing, manufacturing instructions, comprehensive quality review and verification, project definition and initiation, materials definition, specifications, requisitions, procurement, and usage, and final product creation, packaging, and shipping. Importantly, the system and method described enables remote project management, and enables virtual team execution of the drug product manufacturing process. While described here with a focus on clinical trials manufacturing, the invention may be generically employed in any manufacturing setting where manufacturing is accomplished according to a set of predetermined standards.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a tangible medium such as a portable computer diskette, a hard disk, a random access memory (RAM), a read-only memory (ROM), an erasable programmable read-only memory (EPROM or Flash memory), an optical fiber, a portable compact disc read-only memory (CD-ROM), or other tangible optical or magnetic storage device; or transmission media such as those supporting the Internet or an intranet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, pigeon, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages, or in functional programming languages, such as Haskell, Standard Meta Language (SML) or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The following terms may be used herein and may be defined as follows:
“Prescribed standard” may be a set of predetermined requirements for a product or drug product established by the manufacturer and/or a governmental regulatory agency.
“Good Manufacturing Practice” (GMP) may be a standard promulgated by the U.S. Food and Drug Administration.
“Quarantine” may be defined as storage in a secured area of starting materials or drug products while they are undergoing quality assays.
“Standard Operating Procedures” (SOP) may be predetermined procedures that are recognized in an industry for performing a particular function or operation or may be procedures promulgated by an industry standards organization or governmental organization for performing particular functions, operations or procedures.
“Date/timestamp mode” may be a feature to make an unalterable record of the data and time a particular entry is made in the system.
“Product” may be a drug formulation, active pharmaceutical ingredient, biomedical product or other product.
“Quality Manager” may refer to a person designated by a manufacturing team or someone else who has the authority to approve method and actions that may be undertaken to complete a particular step in a test drug manufacturing sequence. The Quality Manager is an expert in the content of the relevant Standard Operating Procedures and in the requirements of Good Manufacturing Practices. The Quality Manager is accountable for verifying the quality and the integrity of each step in the GMP manufacturing process.
“Integrated Quality Assurance System” may be a system to monitor, manage, generate reports and perform other quality functions associated with a manufacturing process. The system may be integrated with the manufacturing process as described in more detail herein. A quality assurance system is essential for manufacturing pharmaceutical products under Good Manufacturing Practices regulations. A quality assurance system may include a collection of Standard Operating Procedure (SOP) documentation and instructions for site preparation and drug manufacturing, manufacturing instruction, comprehensive quality review and verification, project definition and initiation, materials definition, specification; requisition, procurement; usage, final product creation, packaging, shipping, and any other functions associated with manufacturing a product.
“Quality management” is an aspect of the present invention that assures that the product fully complies with all prescribed requirements.
“Project” in one context may mean an endeavor to produce a drug formulation for clinical trials. Project may also mean an endeavor to develop and manage a manufacturing process that may include an integrated quality assurance system and standard operation procedures.
“Remote management” may describe the process of management by one or more persons of a drug product manufacturing process or other manufacturing process who are geographically dispersed, and in general, may not be represented the actual manufacturing site.
“Virtual team” may describe a group of expert personnel who are involved and may be critical to the success of a drug product project, and whose services and expertise may be enabled via the present invention and its associated data that are accessible from geographically dispersed sites.
“Sourcing” may identify a vendor that can supply a particular material or service. Sourcing may include the process of finding the vendor or source.
“Material Specification” may be a collective unit of material used to manufacture the drug product and descriptions of the tests that must be performed on that material by a vendor prior to leaving the source vendor's site and the tests that must be performed by the users prior to utilization of that material in a drug product manufacturing step.

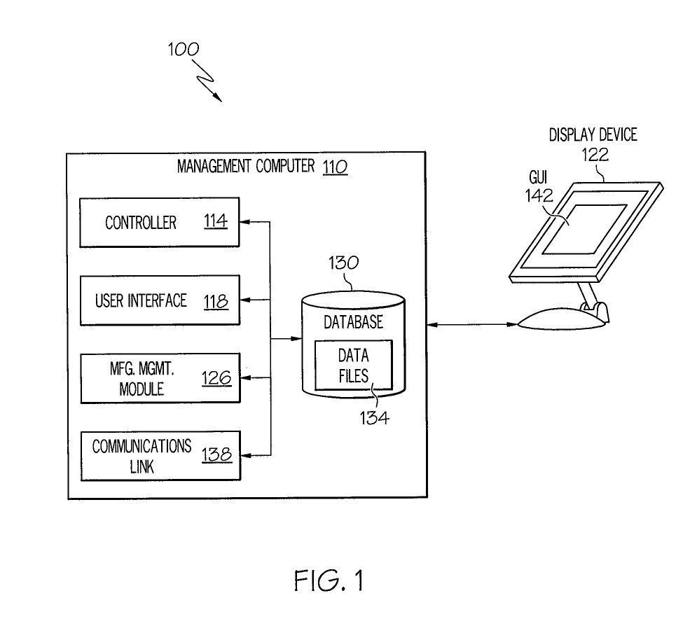

FIG. 1 is a block schematic diagram of an example of a system 100 for managing a manufacturing process, such as a clinical trials manufacturing process, in accordance with an embodiment of the present invention. Accordingly, the system 100 may be used for managing a clinical trials manufacturing (CTM) process. The system 100 may include a management computer 110 or processor that may further include, but is not limited to, a controller 114, a user interface 118, a display device 122, a manufacturing management module or CTM management module or software 126, a database 130 that may include one or more CTM data files 134, and a communications link 138.

Management computer 110 may be any general-purpose computing device, such as, but not limited to, a networked computer, a desktop computer, a laptop computer, a computer workstation, a terminal computer, a server computer, a handheld device (e.g., a personal digital assistant (PDA)), any machine capable of executing a sequence of instructions that specify an action to be taken by that machine, and any combinations thereof. Management computer 110 may be capable of executing program instructions, such as those of manufacturing management module 126.

Controller 114 may be any general-purpose controller or processor for managing the overall operations of management computer 110. In one example, controller 114 may be any controller, processor, or microprocessor device, such as those supplied by Intel Corporation (Santa Clara, Calif.) and Motorola Inc (Schaumburg, Ill.).

User interface 118 may be any one or more computer input/output (I/O) mechanisms, such as, but not limited to, any keypad entry mechanism, such as a standard keyboard; a mouse; a touch screen, a voice-activated mechanism, and any combinations thereof.

Display device 122 may be a standard computer display device, such as a flat-panel display device (e.g., a liquid crystal display (LCD), a light-emitting diode (LED) display, or organic light-emitting diode (OLED) display) or a cathode ray tube (CRT) display device. Furthermore, as a function of management module 126, one or more graphical user interfaces (GUI) 142 may be displayed to a user on display device 122. In one example, GUI 142 may be used for entering and viewing data/information that may be associated with the process of developing and managing a clinical trials manufacturing process. Example of GUIs that may be displayed via display 122 and under the control of management module 126 for developing and managing a manufacturing process will be described in more detail herein.

Management module 126 may be a software application for developing and managing a clinical trials manufacturing process. In one example, management module 126 may be a tool for managing the manufacturing process of a product, such as, but not limited to, drug product relating to the development of a new treatment for Type 2 Diabetes, for the United States (U.S.) Food and Drug Administration (FDA) of Rockville, Md. Management module 126 may used to facilitate tasks, such as, but not limited to, assigning and tracking personnel; defining and administrating projects; specifying, ordering, and tracking materials; managing and tracking inventory; manipulating and reporting manufacturing process information/data; and any combinations thereof.

Database 130 may be a data storage mechanism that resides on the hard drive (not shown) or file system (not shown) of management computer 110, which may be used to store any data and/or information of any suitable file format, such as one or more data or CTM data files 134. For example, data files 134 may be created by the use of management module 126 in the process of managing a clinical trials manufacturing process and may contain data/information that is manually and/or automatically generated. Database 130 may be created and maintained by any suitable database management system, such as, but not limited to, Oracle database software that is available from Oracle Corporation (Redwood Shores, Calif.).

Furthermore, a communications link 138 of management computer 110 provides a wired or wireless mechanism for exchanging information with other entities, such as, but not limited to, other instances of management system 100, via, for example, a local area network (LAN) or wide area network (WAN). In one example, communications link 138 may be an IEEE 802.11 wireless connection, a Bluetooth® wireless connection, one or more RS232 ports, one or more Ethernet ports, one or more universal serial bus (USB) ports, and any combinations thereof. As described in more detail herein, in accordance with one embodiment of the invention a remote desktop connection or the like may enable a user or project participant to link to a terminal server via a network (e.g., using CITRIX and/or Microsoft Terminal Services) so that multiple users in different geographical locations can access the same software or modules concurrently. This connectivity is what enables virtual teams or participants and remote management of the project team or participants.

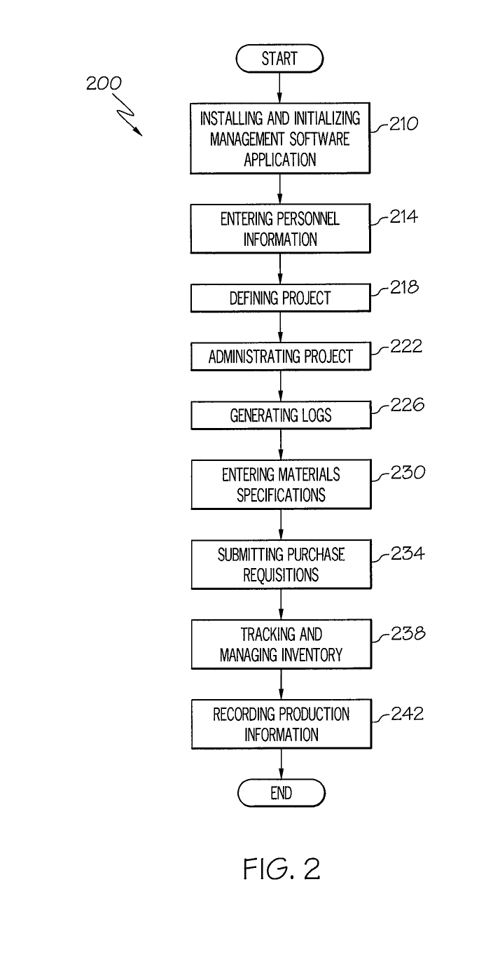

FIG. 2 is a flow chart of an example of a method 200 for managing a manufacturing process, such as a clinical trials manufacturing process, in accordance with an embodiment of the present invention. The method 200 may be embodied in and performed by the system 100 of FIG. 1. In block 210, a management software application or processing management module for managing a manufacturing process, such as managing a clinical trials manufacturing process or other manufacturing process, may be installed and initialized upon a general-purpose computing device. In one example, CTM management software or manufacturing management module 126 may be installed and initialized upon management computer 110 of system 100 of FIG. 1. More specifically, one example installation process may include, but is not limited to, (1) installing a Cisco VPN client and configuring the client to connect to a database hosting facility, (2) installing a Microsoft SQL Server Client Network Utility, (3) configuring an open database connectivity (ODBC) data source for connecting to data. (4) creating a folder on a selected drive that may be labeled CTM, manufacturing management application or similar designation, (5) copying executable and associated data files for execution of the CTM software from a CTM universal serial bus (USB) Key or other provided source, (6) opening an initialization file, such as a “ctm.ini” file, and configuring it to connect to a test, training, or production data source, and (7) right clicking on a CTM.exe file and selecting “send->to Desktop.” Upon successful installation of the management software application, such as CTM management software or manufacturing management module 126, a main menu of the application may be initialized by selecting, for example, a “CTM icon” on a user's desktop, which directs the user to, for example, a log in menu by which the user may enter a “username” and “password.”

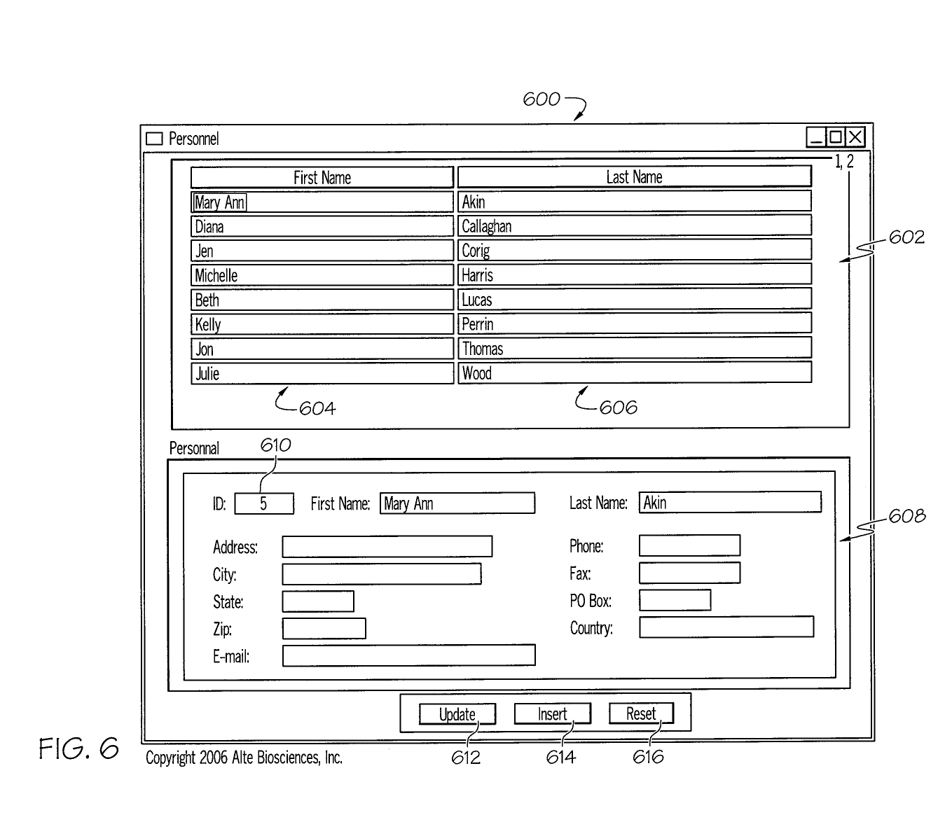

In block 214, information for one or more personnel that may be associated with the clinical trials manufacturing process or other manufacturing process may be entered. For example, personnel information may be entered and/or reviewed via an exemplary GUI illustrated in FIG. 6 for generating a list of personnel and their associated information.

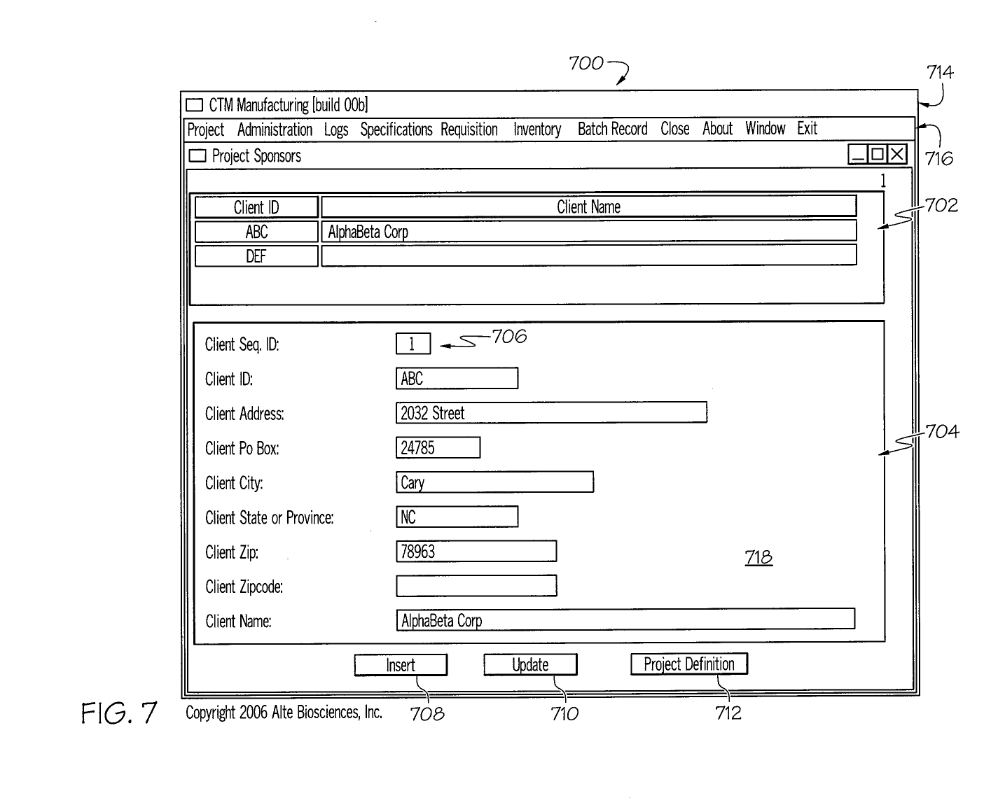

In block 218, one or more projects that may be associated with the manufacturing process, such as a clinical trials manufacturing process or other manufacturing process, may be defined. For example, project administration information may be entered/reviewed via exemplary GUIs such as those shown in FIGS. 7, 8, and 9 for entering, for example, but not limited to, project sponsor information, project detail information, and project personnel information for each of the one or more projects.

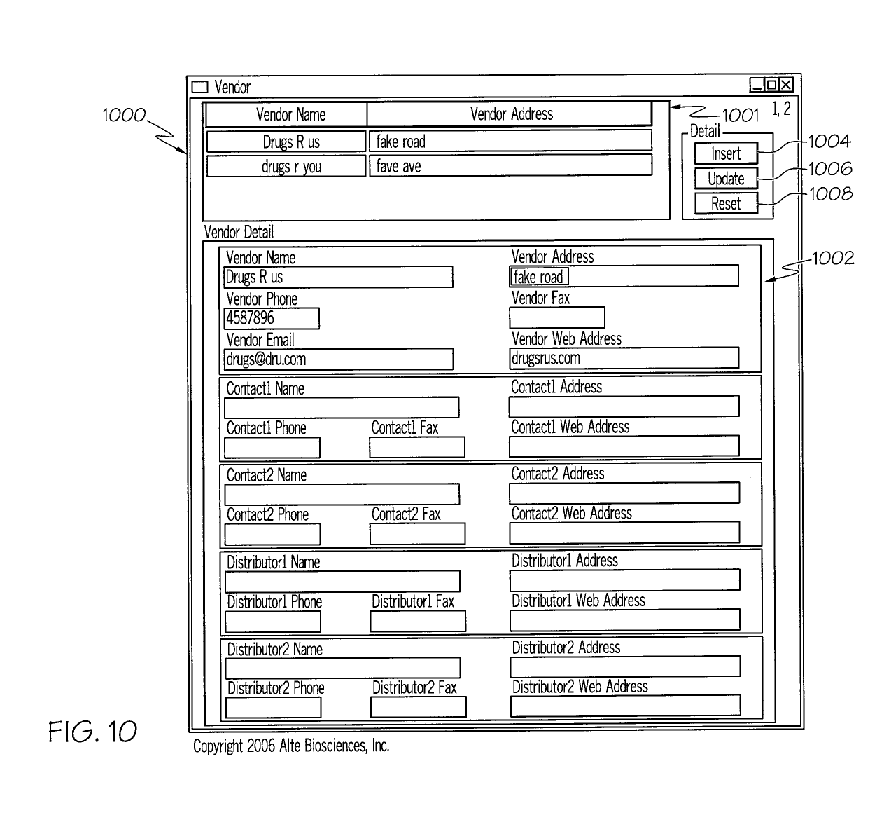

In block 222, one or more projects that are associated with the clinical trials manufacturing process or other process may be administrated. For example, materials management information may be entered/reviewed via the exemplary GUIs that that may be similar to that shown in FIGS. 10 through 19 for entering, for example, but not limited to, vendors, a list of materials, material types, material packages, material status, material conditions, material packages, storage conditions, units, facilities, equipment, rooms, tests, and methods that are associated with the clinical trials manufacturing process.

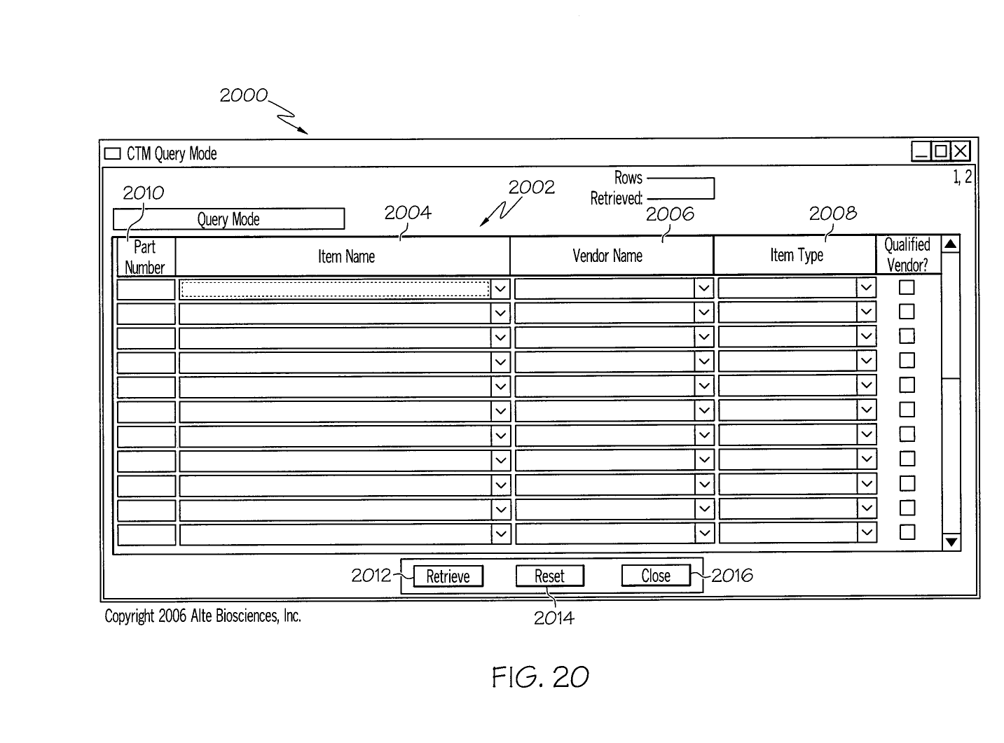

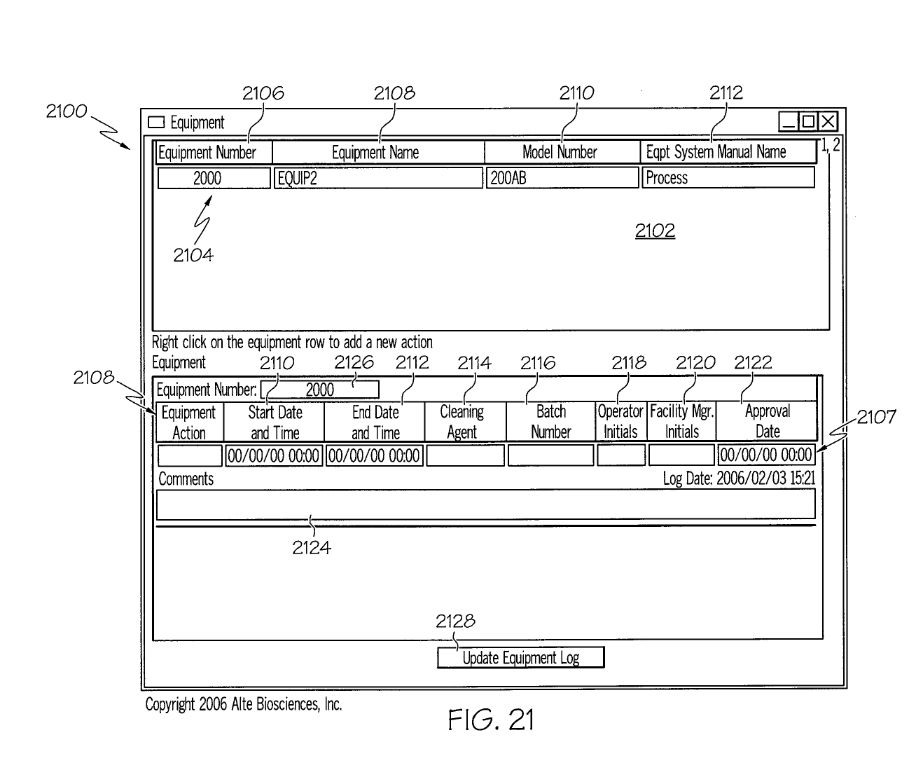

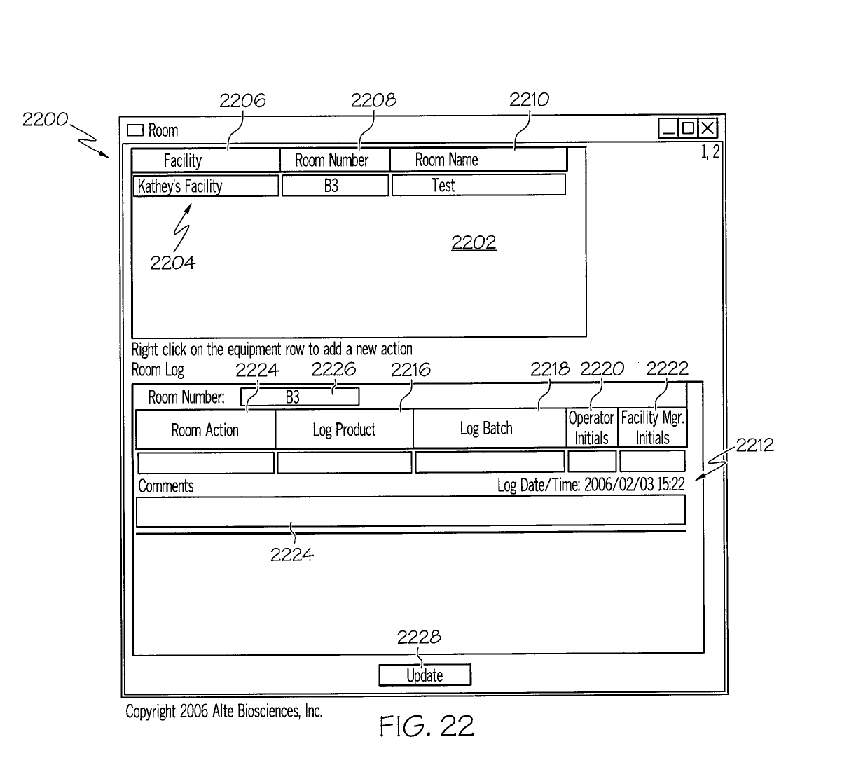

In block 226, one or more logs that are associated with the process or clinical trials manufacturing process and queries associated with manufacturing parts may be generated. For example, parts information may be queried via an exemplary GUI similar to that shown if FIG. 20 and information may be entered and reviewed via the exemplary GUIs similar to that shown in FIGS. 21 and 22 for entering, for example, but not limited to, an equipment log and a room log.

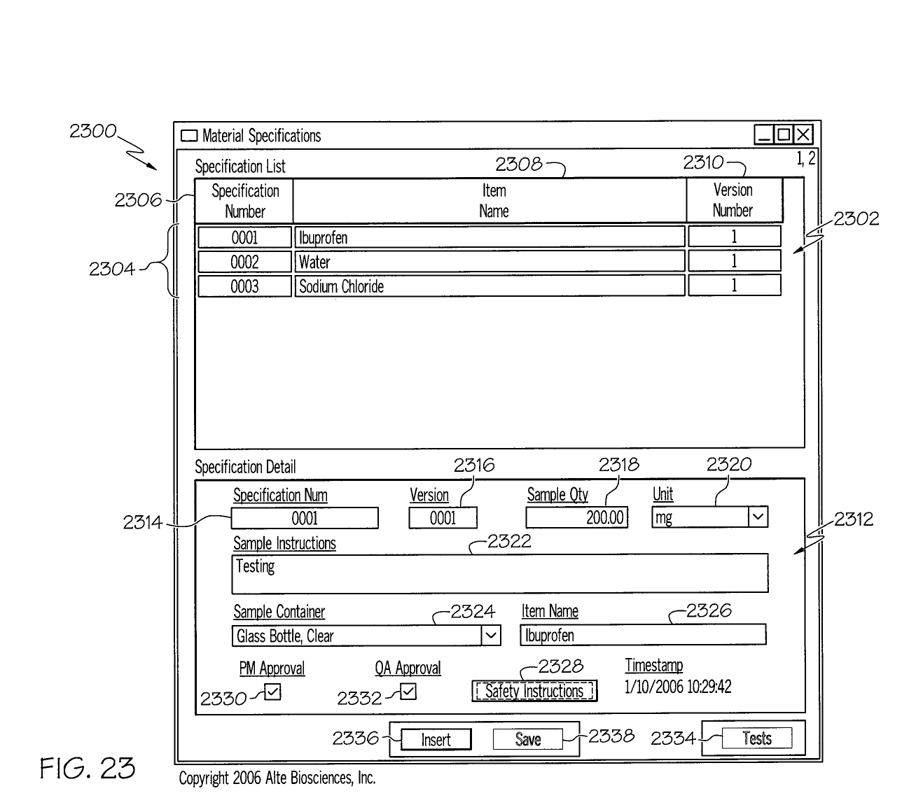

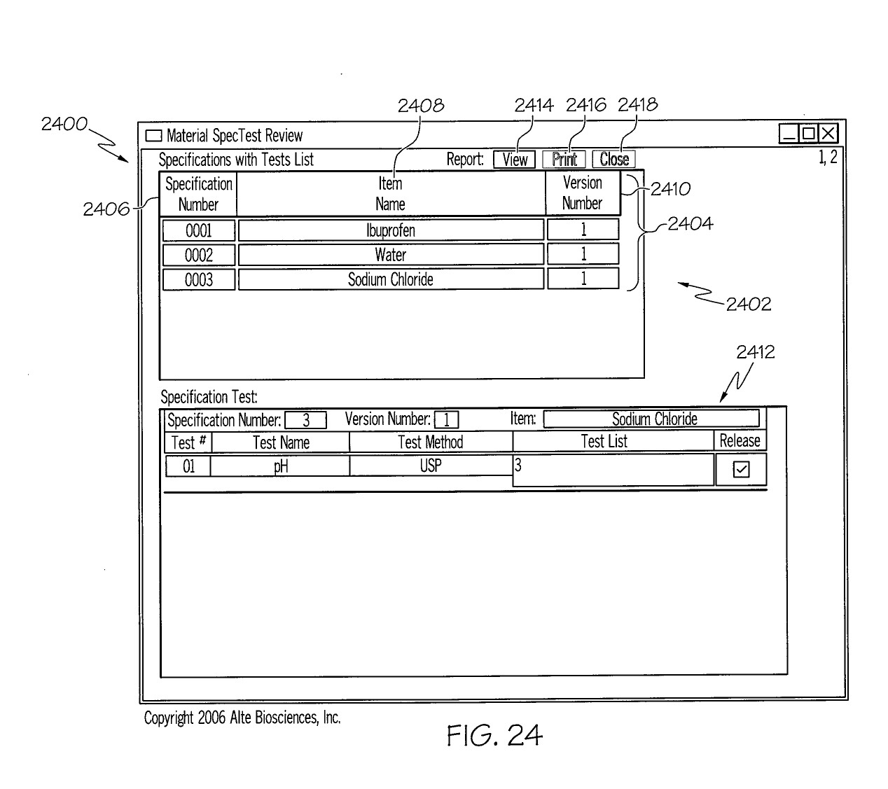

In block 230, materials specifications that are associated with the process or clinical trials manufacturing process may be entered. Materials specifications information may be entered and reviewed via GUIs similar to the exemplary GUIs shown in FIGS. 23 and 24 for entering, for example, but not limited to, a list of material specifications and material specification tests.

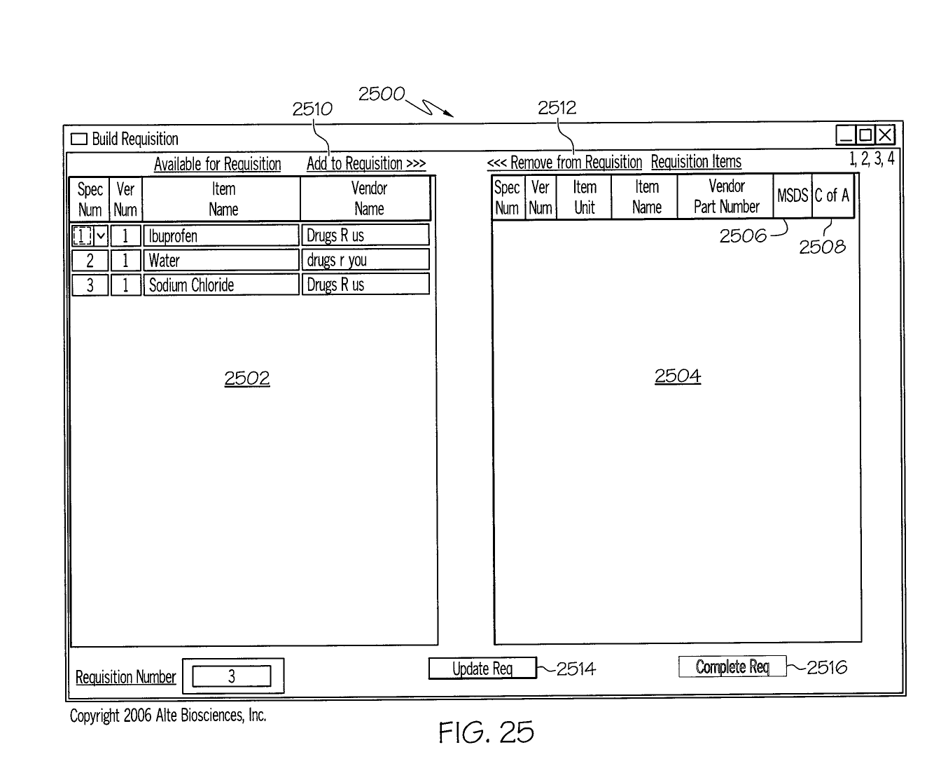

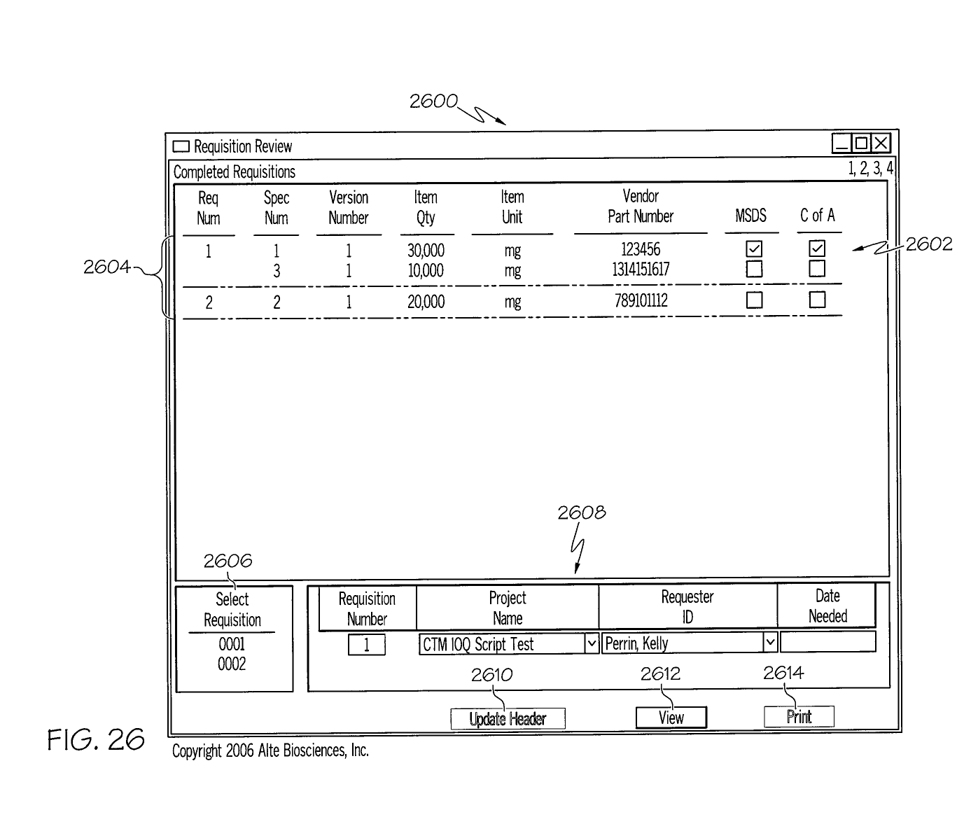

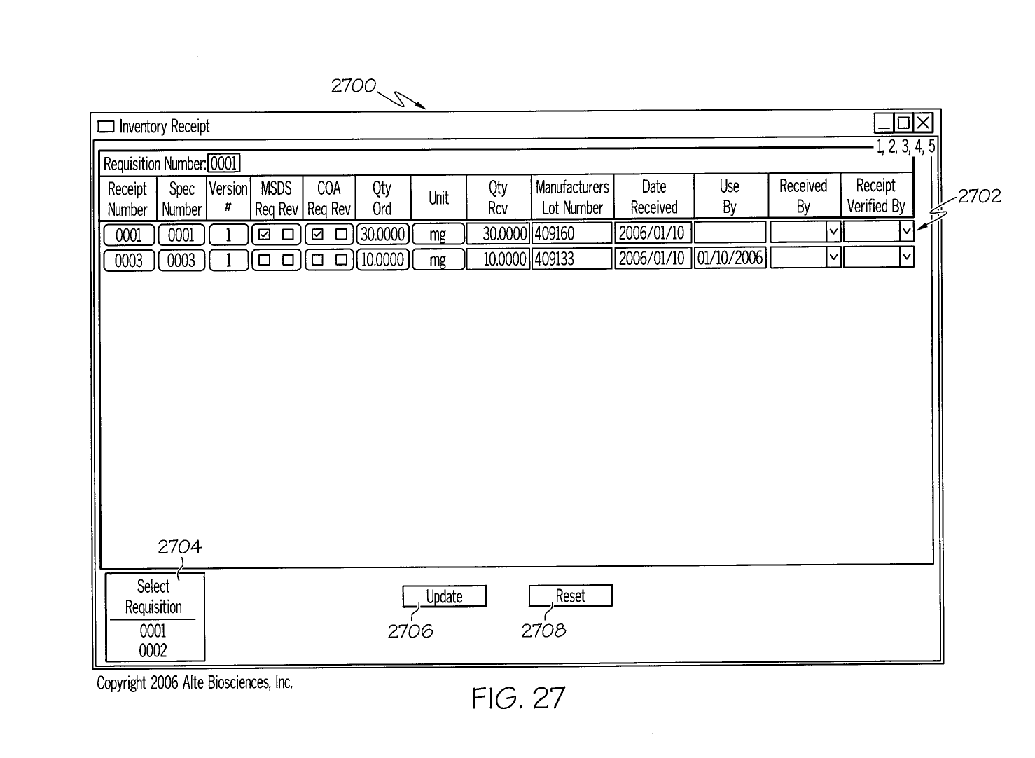

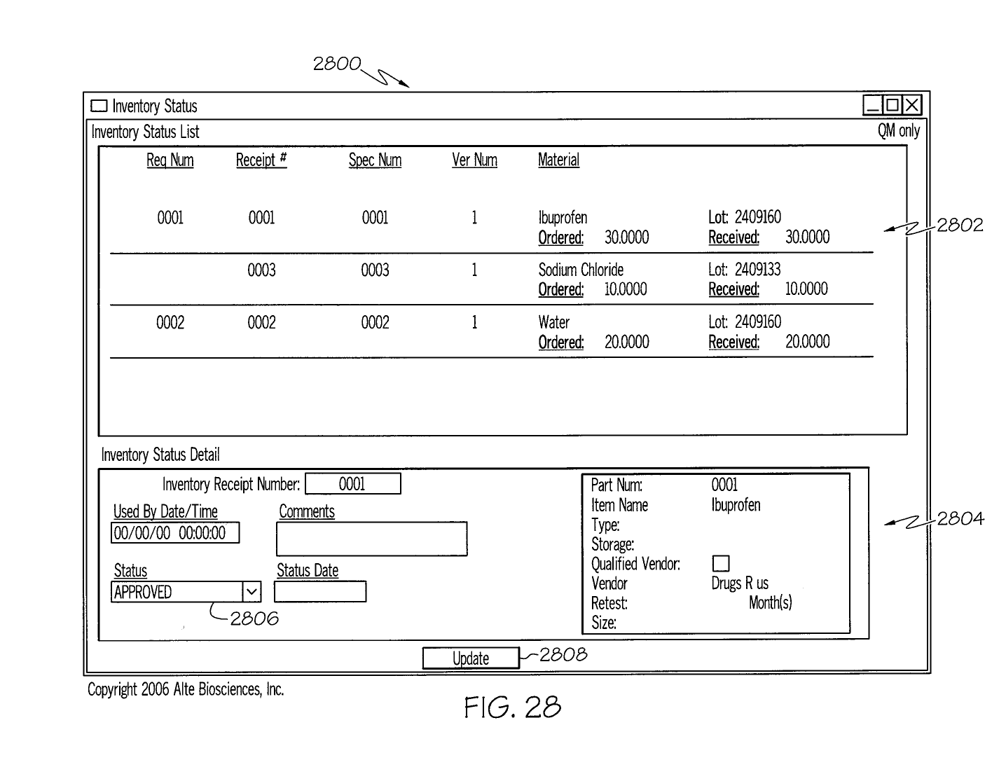

In block 234, purchase requisitions that are associated with the manufacturing process or clinical trials manufacturing process may be submitted. For example, purchase requisitions information may be entered/reviewed via GUIs similar to the exemplary GUIs shown in FIGS. 25 and 26 for, for example, but not limited to, information for building purchase requisitions and reviewing purchase requisitions.

In block 238, inventory that is associated with the clinical trials manufacturing process or other process may be tracked and managed. For example, inventory information may be entered and reviewed via GUIs similar to the exemplary GUIs shown in FIGS. 27 through 30 for monitoring, for example, but not limited to, the receipt of inventory, inventory status, inventory usage, and depleted inventory.

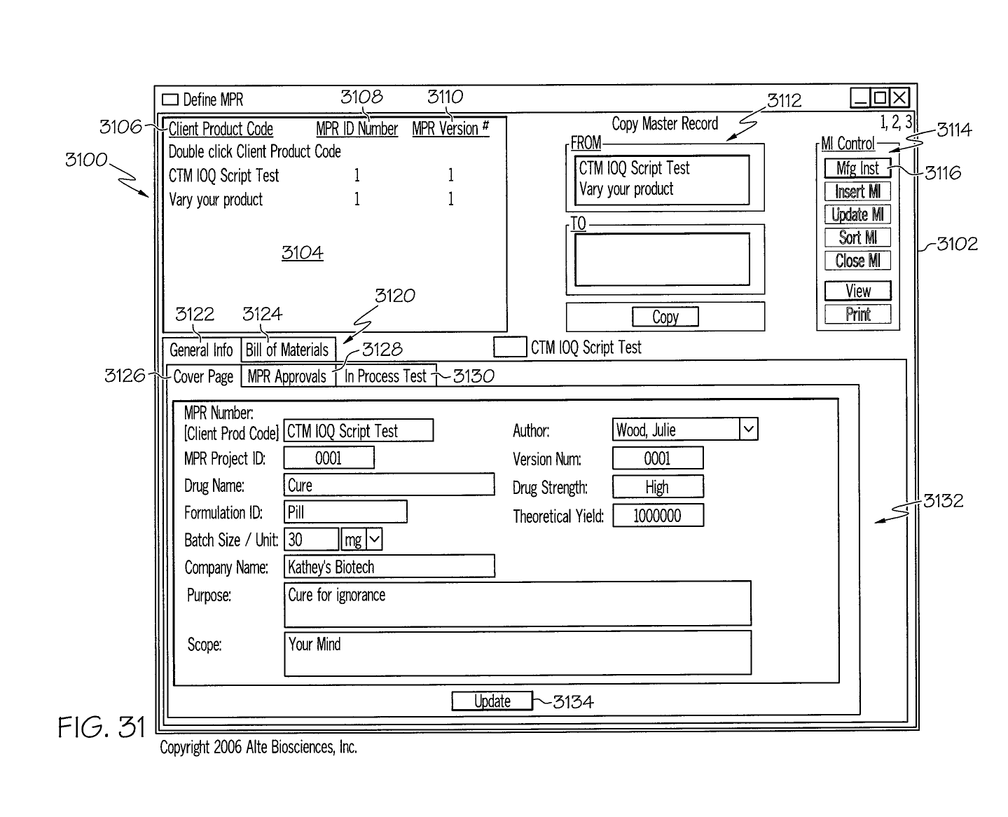

In block 242, production information that is associated with the clinical trials manufacturing process or other process may be recorded. For example, production information may be entered/reviewed via GUIs similar to the exemplary GUIs shown in FIGS. 31 through 38 for entering, for example, but not limited to, a master production record (MPR) definition; batch production record (BPR) definition; equipment, materials, process tests, and approvals that are associated with the production records. The MPR serves as a template/baseline requirement definition for each production batch initiated. Use of the MPR forces adherence to a baseline while allowing multiple instances of that requirement to be initiated at different times, all of which can be monitored and reviewed/validated independently. The BPR is a record of each batch run.

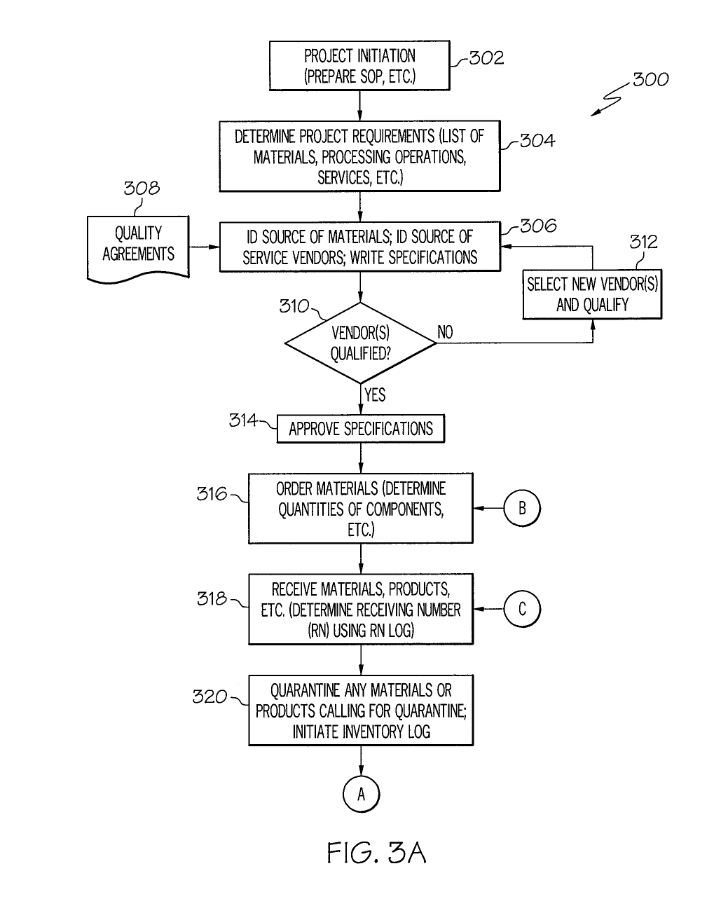

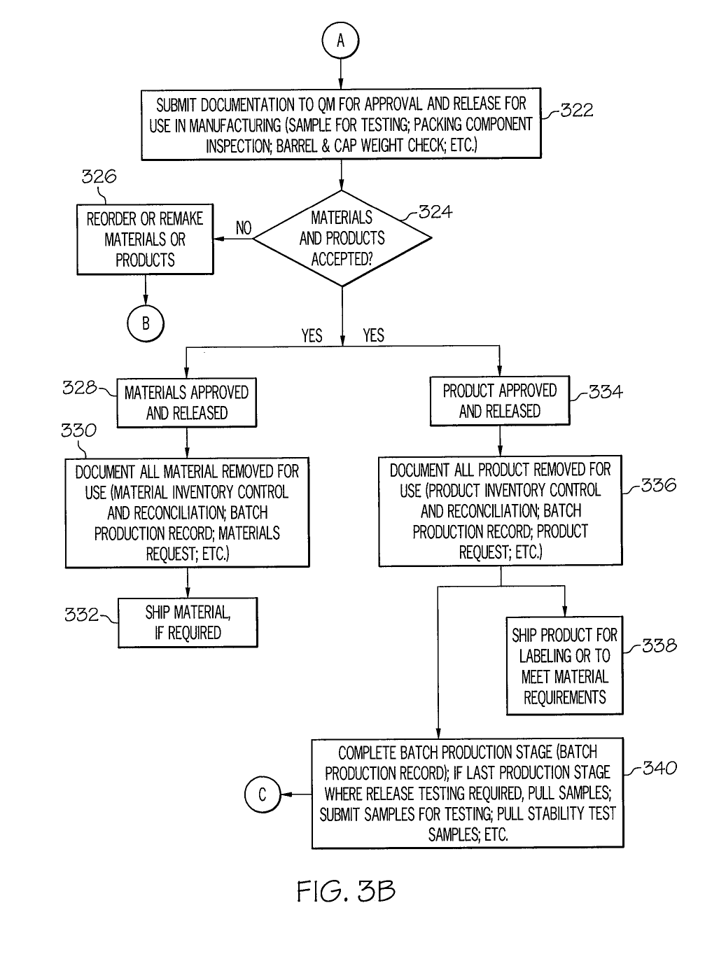

FIGS. 3A and 3B (collectively FIG. 3) is a flow chart of an example of a method 300 for developing and managing a manufacturing process, such as a clinical trials manufacturing process, in accordance with another embodiment of the present invention. In block 303, project initiation may be performed. Project initiation may include preparing standard operating procedures (SOP) to define any operations associated with a manufacturing process. The SOPs may include industry recognized procedures for certain processes or sub-processes that may be associated with the manufacturing process. Project initiation may also include any other preliminary operations to start a particular project for developing a manufacturing process including management of the manufacturing process for a clinical trial manufacturing process for a drug product or manufacturing process for another product.

In block 304, project requirements for developing and managing the manufacturing process for the product may be defined. The project requirements may include a list of materials, information related to each material, any equipment required, specification of any equipment, processing operations, services and any other requirements that may be required for manufacturing a particular drug product or other product.

In block 306, sources for materials may be identified. Sources of services or service vendors may also be identified. Specifications for any materials, equipment or services may be written in block 306. Quality agreements with any vendors may be considered during the process of identifying sources or vendors.

In block 310, a determination may be made for each vendor if the vendor is qualified. If a vendor for a particular material or service in not qualified, a new vendor may be selected and qualified in block 312. The process of identifying sources of materials and services in block 306 and determining if each vendor is qualified in block 310 may continue until all vendors needing to be qualified have been qualified. The method 300 may then advance to block 314.

In block 314, the specification may be reviewed and approved.

In block 316, materials may be ordered. Quantities of each of the materials or components may be determined and ordered from the source or vendor previously identified.

In block 318, materials may be received. A receiving number (RN) may be determined or assigned using a receiving number log.

In block 320, any materials or products requiring quarantine may be quarantined. An inventory log similar to that described herein may also be started to track and monitor inventor of materials.

In block 322, documentation related to the materials or products quarantined may be submitted to quality management for approval and release for use in manufacturing. Quality management may sample the materials for testing and perform any other quality control operations to ensure the materials are acceptable for use in manufacturing the product.

In block 324 a determination may be made if the materials and products have been accepted. Any materials or products that have not been accepted may be reordered or remade in block 326. If a material is reordered, the method 300 may return block 316 with respect to that material and the method 300 may continue as previously described until all materials for a product have been accepted. The method 300 may then advance to blocks 328 for materials and block 334 for products.

In block 328, the accepted materials may be approved and released for the manufacturing process or clinical trials manufacturing process.

In block 330, all material removed for use may be documented. The material inventory may be controlled and reconciled as described herein using the exemplary GUIs shown in FIGS. 27-30. In block 332 any material may be shipped, if required.

In block 334 an accepted product may be approved and released. In block 336, all product removed for use in the process may be documented. This may be done using product inventory control and reconciliation; using a batch production record; products request or similar means.

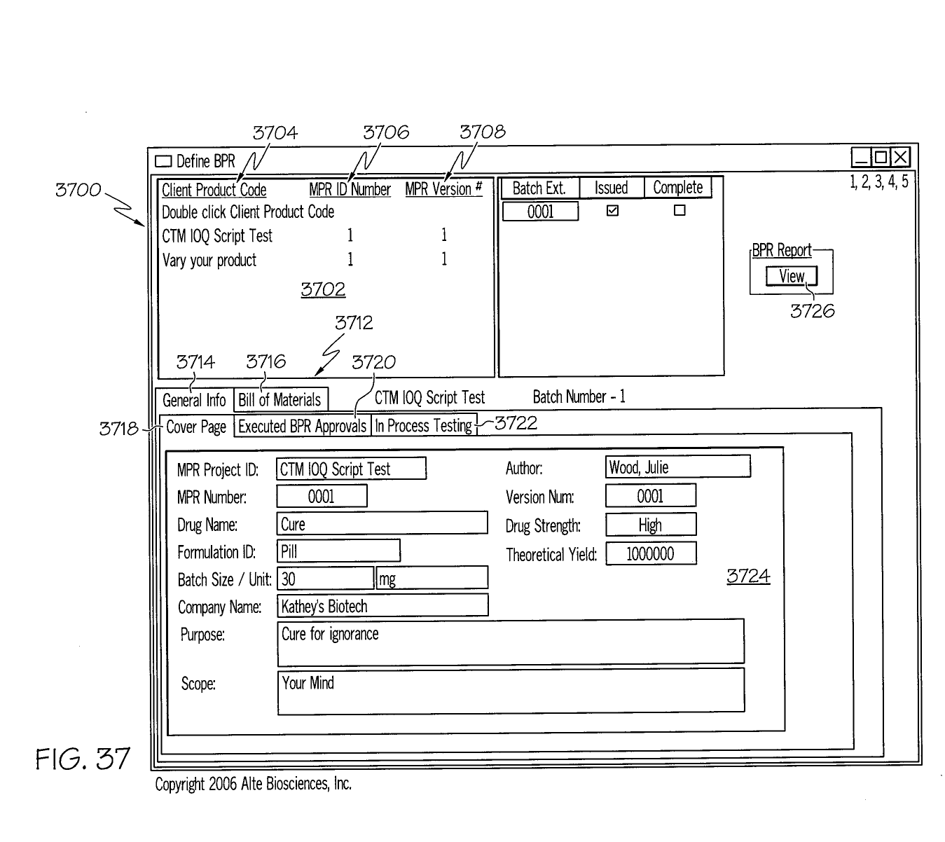

In block 338, product may be shipped for labeling or to meet material requirements. In block 340, a batch production stage may be completed. A batch production record may be completed as described herein with reference to FIG. 37. If the batch production is the last production stage where release testing may be required, samples of the product may be pulled and submitted for testing. Samples may be tested for stability of the process. The method 300 may return to block 318 for another batch production stage if the current stage is not the last one. The method 300 may then continue as previously described.

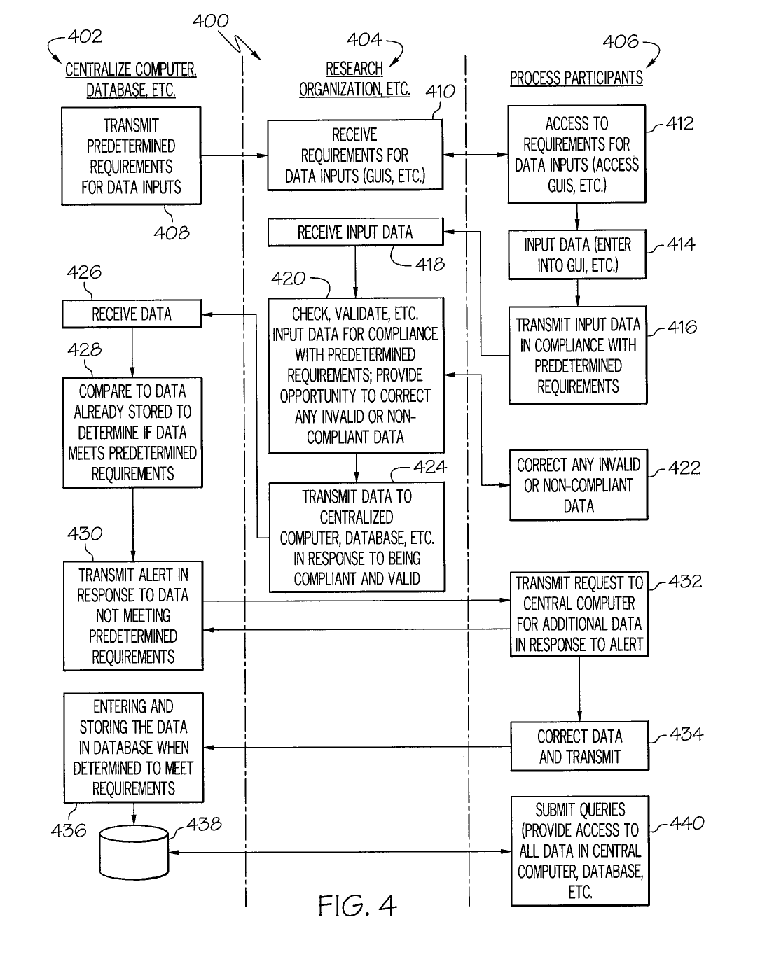

FIG. 4 is a flow chart of an example of a method 400 for developing and managing a manufacturing process, such as a clinical trials manufacturing process, using multiple geographically disperse participants in accordance with an embodiment of the present invention. The method 400 may be divided into blocks or operations that may be performed by or at a centralized computer 402, database, or the similar device; blocks or operations that may be performed by a research organization 404 or entity sponsoring the project to develop the manufacturing management process; and blocks or operations that may performed by a process develop participants or project participants 406. In another embodiment of the present invention, the research organization 404 may include or incorporate the centralized computer 402 and/or database.

In block 408, predetermined requirements for data inputs may be transmitted from the centralized computer to the research organization. The process participant 406 may access the requirements from the research organization or in another embodiment directly from the centralized computer 402. The predetermined requirements may be accessed via a GUI or GUIs similar to the GUIs described herein. In another embodiment of the present invention, the predetermined requirements may be determined or defined by the research organization 404 and may be stored at the centralized computer 402 for access by the process participants 406. Alternatively, the research organization 404 may maintain the predetermined requirements for access by the process participants 406.

In block 414, data may input by the process participant 406. The data may be entered into a GUI or GUIs similar to those described below or by other means. In block 416, the input in compliance with any predetermined requirements may be transmitted to the research organization 404 by the process participant 406.

In block 418, the input data is received. In block 420, the input data may be checked for validity, compliance with any predetermined requirements, accuracy, and completeness or for other purposes. The process participant 406 may be provided an opportunity to correct any invalid, incomplete, inaccurate or non-compliant data in blocks 420 and 422.

In block 424, the checked data may be transmitted to the centralized computer 402 or database in response to being compliant and valid. In another embodiment, the research organization 404 may maintain the data and perform the operations of the centralized computer 402.

In block 426, the data may be received by the centralized computer 402 or database system. In block 428, the data may be compared to any data already stored or to other benchmarks to determine if the data meets the predetermined requirements.

In block 430, an alert or other notification may be sent to the process participant 406 that collected and transmitted the data in response to the data not meeting the predetermined requirements.

In block 432, the process participant 406 may collect additional data or correct the data in response to receiving the alert or notification. The additional data and/or corrected data may be returned to the centralized computer 402 or database in block 434.

In block 436, the data may be entered and stored in the database 438 in response to meeting the requirements. In block 440, any process participant 406 may submit queries to access the data.

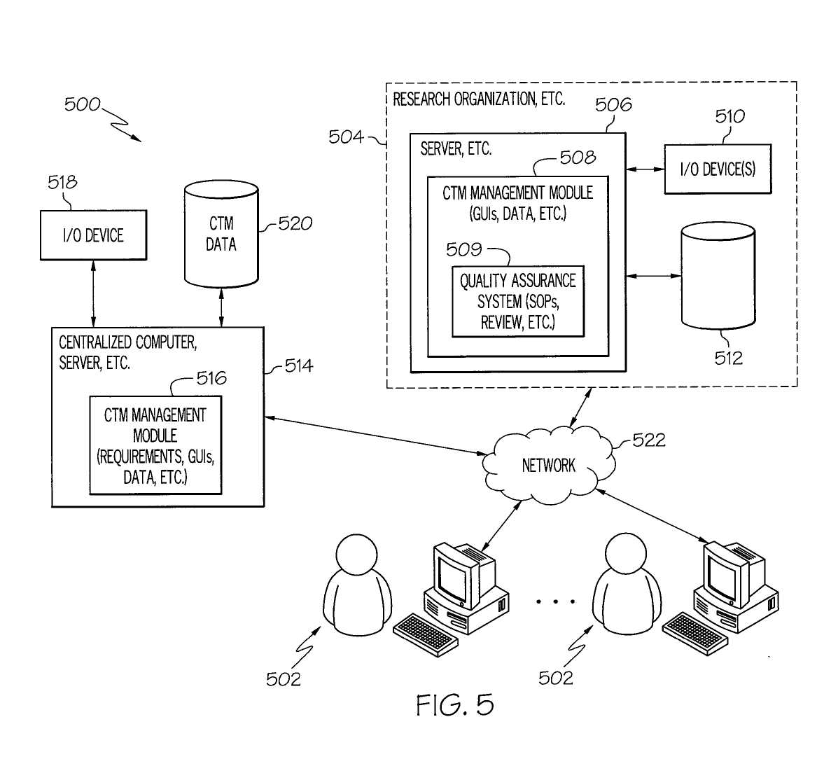

FIG. 5 is a block schematic diagram of an example of a system 500 for developing and managing a manufacturing process, such as a clinical trials manufacturing process, using multiple disperse participants 502 in accordance with an embodiment of the present invention. The multiple disperse participants 502 may be or may include a geographically dispersed virtual team of experts. The participants 502 may be experts in different areas or fields associated with the manufacturing process, quality assurance, the product itself or other aspects. The methods 200, 300 and/or 400 may be embodied in and performed by the system 500. Each of the participants 502 may include a computer system similar to the computer system 100 of FIG. 1.

One important feature of one embodiment of the invention is enablement of a virtual team of geographically dispersed expert personnel, who manage and monitor the actual drug product manufacturing process. As previously described, the participants 502 may be or may include the virtual team of geographically dispersed expert personnel. This integrated team can initiate the project or drug product project, and execute the prescribed business and scientific methods that will produce and deliver the drug product, active pharmaceutical ingredient, or other product. For example, the functions of the virtual team may include, but is not necessarily limited to planning and procurement of acceptable starting materials, manufacturing, quality testing, storage, inventory control, shipping and other functions. The team may be dedicated to the process on an as needed basis. The team can also install the systems into existing manufacturing facilities and train the facility staff in the quality systems and operation of any software, equipment or other systems. The Quality Assurance person (Quality Manager) or group may be part of this team and may be responsible for developing and implementing quality assurance standards, processes, and controls and may approve vendors, specifications, methods for inspection, methods for testing, methods for sampling, master production records and batch production records. An embodiment of the present invention may provide a means for gated processes, whereby the prescribed workflow can only proceed after the designated Quality Assurance person has verified that processes were executed appropriately, that any deviations from plan were appropriate and were appropriately documented.

The system 500 may include a research organization 504 or similar organization. The research organization 504 may include a server 506 or similar computing device. A manufacturing management module 508 or CTM management module may be operable on the server 504. One or more of the methods 200, 300 and 400 or combinations of features thereof or components of the methods may be embodied in the management module 508. For example, the management module 508 may embody and perform the operations described as being performed by the research organization 404 in FIG. 4.

A quality assurance system 509 or module may also be embodied on the server 506. The quality assurance system 509 may be integrated with the manufacturing management module 508. As previously described, the quality assurance system 509 may include a collection of Standard Operating Procedure (SOP) documentation and instructions for site preparation and drug manufacturing, manufacturing instruction, comprehensive quality review and verification, project definition and initiation, materials definition, specification; requisition, procurement; usage, final product creation, packaging, shipping, and any other functions associated with manufacturing a product.

Input devices, output devices or combination input/output devices 510 may be provided to permit control of the server 506 and the management module 508 by a user or administrator. A database 512 may also be associated with the server 506 to store data used by or generated by the management module 508 and that may be provided by the process or project participants 502.

The system 500 may also include a centralized computer system or server 514. A manufacturing process management module 516 or CTM module may be operable on the centralized computer 514. One or more of the methods 200, 300 and 400 or combinations thereof or components of the methods may be embodied in the management module 516. For example, the management module 516 may embody and perform the operations described as being performed by the centralized computer 402 in FIG. 4.

In accordance with an embodiment of the present invention, the quality assurance system 509 may be associated with the management module 516 on the centralized computer 514. The quality assurance system may be integrated with the management module 516. In a further embodiment, some functions or operations of the quality assurance system 509 may be embodied on the server 506 and other functions or operations may be embodied on the central computer 514

Input devices, output devices or combination input/output devices 518 may be provided to permit control of the centralized computer 514 and the management module 516. A database 520 may also store data associated with the management module 516 and provided by the process or project participants 502.

The process participants 502, research organization 504 and centralized computer 514 may communicate with one another and transfer data via a network 522. The network 522 may be the Internet, a private network or other type network.

In another embodiment of the present invention all operations or functions of the centralized computer 514 may be incorporated in the server 506 at the research organization 504.

FIG. 6 is an example of a GUI 600 to facilitate entering and managing personnel associated with developing and managing a manufacturing process or CTM management process in accordance with an embodiment of the present invention. The GUI 600 may be generated as part of the operations in block 214 of the method 200 of FIG. 2. In one example, when a user is logged in as an administrator, project manager, quality manager, or facility manager, or the like, the user may have access to adding personnel to the system or process via the exemplary GUI 600.

The GUI 600 may include two sections and three buttons. A first section 602 may be a list of personnel including fields 604 and 606 for the first and last names of every person that is currently in a data source or database associated with the manufacturing management module or CTM application or module, such as applications or modules 126, 508 or 516 of FIGS. 1 and 5, respectively. Clicking-on a name in the first section 602, using a computer pointing device or mouse as is commonly known, will cause a second section 608 to become populated with detailed personnel information associated with the person whose name was clicked-on. All fields in the second section 608 or personnel detail section may be editable except for an ID number field 610. The ID number may be assigned by the application or module or by some other entity, such as the individual's employer. An update button 612 may be used to save any information that is entered or edited in second section 608. An insert button 614 may be used to add a new person to the system. Clicking on the insert button 614 may open the personnel detail or second section 608 with all fields being blank. Once a person's information is entered, the user may click the update button 612 to save the information. A reset button 616 may be used to cancel and clear any editing in the second section 608. Once clicked, reset button 616 clears the window, not saving any changes that have been made.

The exemplary GUIs illustrated in FIGS. 7, 8, and 9 may be generated as part of the operations of block 218 of method 200 of FIG. 2. FIG. 7 is an example of a GUI 700 to facilitate entering and managing or recording project sponsors associated with developing and managing a manufacturing process in accordance with an embodiment of the present invention. The GUI 700 may be referred to as a project sponsors GUI. The project sponsors GUI 700 may include two sections and three buttons. A first section 702 may include a client list, which shows an ID and name of every client that is currently in the data source or database associated with the application or manufacturing management module. Clicking on a name in the first section 702 will cause a second section 704, which is a client detail section, to become populated. Second section 704 may define a section that contains information on the client selected in the first section 702. All fields in the second section 704 may be editable, except for a Client Seq. ID number field 706, which may be assigned by the application or manufacturing management module.

An insert button 708 may be used to add a new client to the system. Clicking on insert button 708 using a computer pointing device or mouse may open the client detail section or second section 704 with all fields being blank. An update button 710 may be used to save any information that is entered or edited in second section 704 or the client detail section. Once the client's information is entered, an update button 710 may be clicked or operated using the computer pointing device in order to save the information. A project definition button 712 may be used to open a project definitions GUI, such as the exemplary project definition GUI 800 illustrated in FIG. 8. Note that the main menu for the system may be the open application with the title bar 714 and tool bar 716 as shown FIG. 7, but with a blank application space or forms area 718.

FIG. 8 is an example of a GUI 800 to define a project associated with developing and managing a manufacturing process in accordance with an embodiment of the present invention. The GUI 800 may be referred to as a project definitions GUI. The project definitions GUI 800 may include two sections and two buttons. A first section 802 may include a list 804 of projects. The list of projects may include fields for a client ID 806, a product code 808, a project title 810 and any other information that may be appropriate to identify current projects. The list of projects 804 may be stored in the data source or database associated with the application or module. Clicking on a project in the list 804 will cause a second section 812, which is a project definition detail section, to become populated. Second section 812 may contain fields containing information or data associated with the project that is selected in the first second 802. Examples of the fields may include a detailed project description field 814 and status information fields 816 that may correspond to different requirements associated with the selected project. Examples of the project status fields 816 or different requirements may include personnel assigned, equipment defined, order equipment, equipment IQ/OQ, Qualify vendors, develop specs, order raw materials, release raw materials, approve master production record (MPR), and any other fields that may be helpful in defining the status of the project such as those illustrated in FIG. 8. A checkable “Req?” box 818 may be associated with each project status field 816 to indicate whether the particular requirement or criteria may be required. A “Complete” field or box 820 may also be associated with each project status field 816 to enter a date or other information when a requirement has been satisfied or completed. All fields in the second section 812 may be editable.

An insert button 822 may be used to add a new project to the system. Clicking on the insert button 822 may open the project definition detail section 812 with all fields being blank. An update button 824 may be used to save any information that is entered or edited in second section 812. Once the project's information is entered, update button 824 may be clicked in order to save the information.

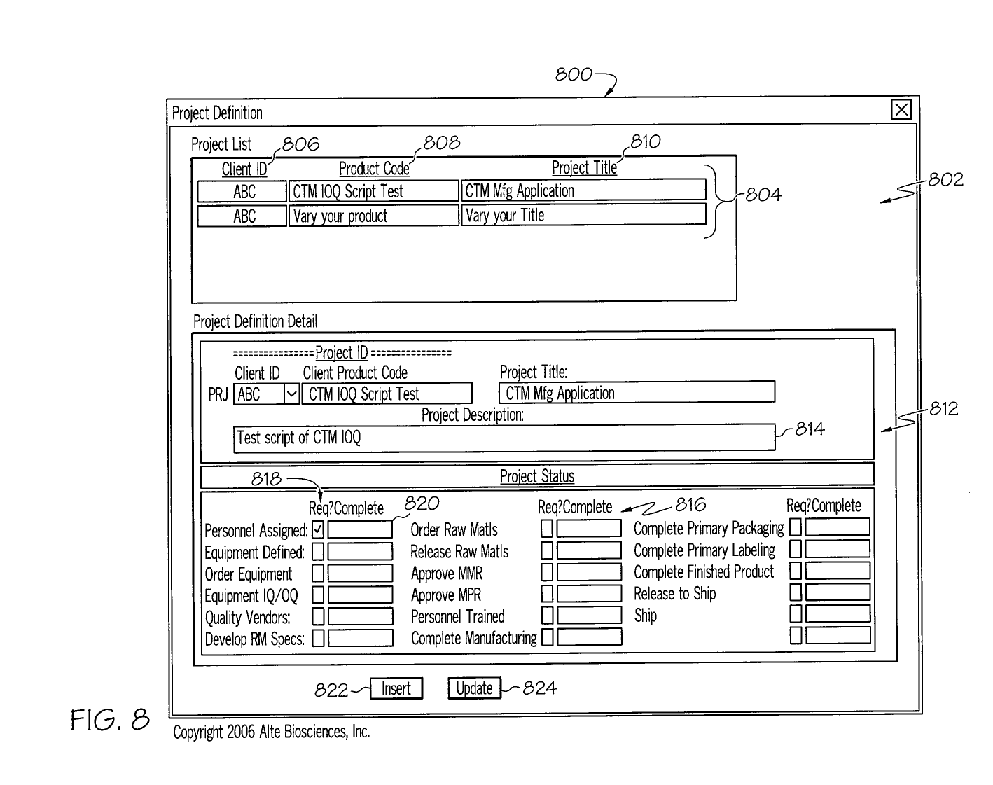

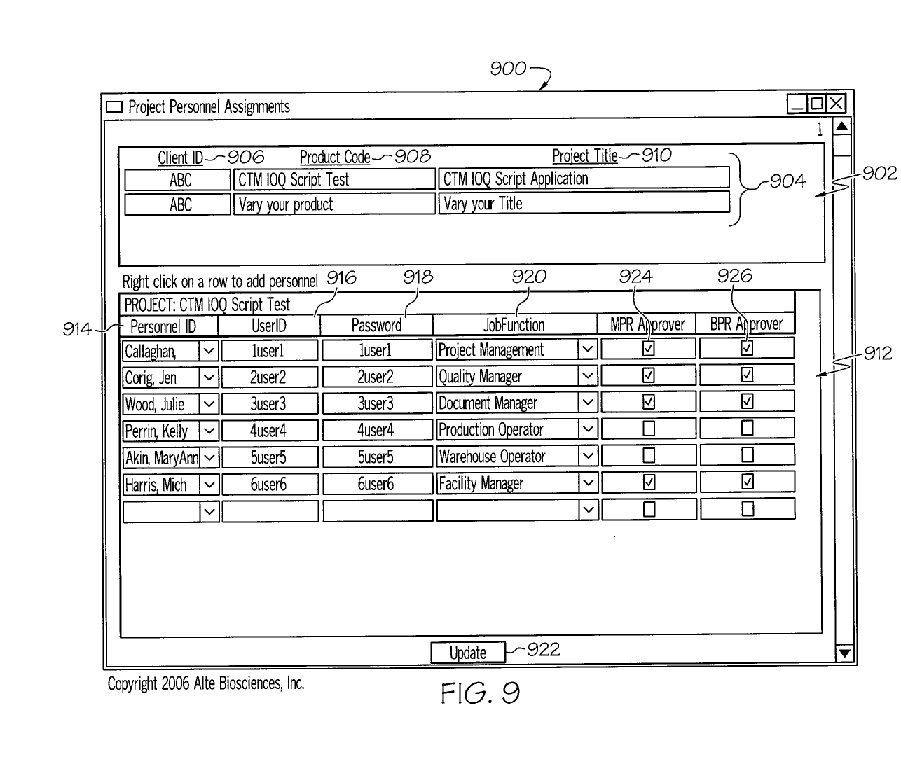

FIG. 9 is an example of a GUI 900 to assign personnel to a project associated with developing and managing a manufacturing process in accordance with an embodiment of the present invention. The GUI 900 may be referred to as a personnel assignment GUI. The personnel assignment GUI 900 may have two sections and one button. A first section 902 may be a project list 904, which shows a client ID 906, a product code 908, a project title 910 and any other information deemed appropriate to identify the project or include in the first section 902. The first section 902 may include every project that is currently in the data source or database that is associated with the CTM application or manufacturing management module. Clicking on a project in the first section 902 will cause a second section 912 or personnel detail section, to become populated. Second section 912 contains a list of people assigned to the selected project. Right clicking on a row allows a user to assign new personnel to the project selected in the first section 902. The personnel detail section 912 may include fields for entering information associated with each person assigned to the project selected in the first section 902. Examples of the fields may include a Personnel ID 914, a User ID 916, a Password 918, a Job Function 920 and any other information that may be appropriate about the assigned person. All fields in the second section or personnel detail section 912 are editable. An update button 922 may be used to save any information that is entered or edited in second section 912 or the personnel detail section.

The second section 912 may also include a master production record (MPR) approve box 924 associated with each person and a batch approver (BPR) box 926 associated with each person. Clicking on the MPR approver box 924 makes the selected person an approver on MPRs associated with this project. In one example, MPRs cannot be issued until all approvers have signed. Clicking on the BPR approver box 926 makes the selected person an approver on BPRs associated with the project selected in the first section 902. In one example, BPRs cannot be issued until all approvers have signed.

The exemplary GUIs illustrated in FIGS. 10 through 20 may be generated as part of the operations associated with block 222 of the method 200 of FIG. 2.

FIG. 10 is an example of a GUI 1000 to enter and record vendor information associated with developing and managing a manufacturing process in accordance with an embodiment of the present invention. The vendor GUI 1000 may include two sections and three buttons. A first section 1001 is the vendor list, which shows the vendor name and address of every vendor that is currently in the data source or database associated with the manufacturing management application. Double clicking on a vendor name in the first section 1001 or vendor list will cause a second section 1002 or vendor detail section, to become populated. Second section 1002 may contain information on the vendor selected in the first section 1001. All fields in this section are editable. An insert button 1004 may be used to add a new vendor to the system. Clicking on the insert button 1004 opens the vendor detail section 1002 with all fields being blank. An update button 1006 may be used to save any information that is entered or edited in the vendor detail section 1002. Once the vendor's information is entered, an update button 1006 may be clicked in order to save the information. A reset button 1008 may be used to cancel and clear any editing in second section 1002 or vendor detail section. Once clicked, reset button 1008 clears the window, not saving any changes that have been made.

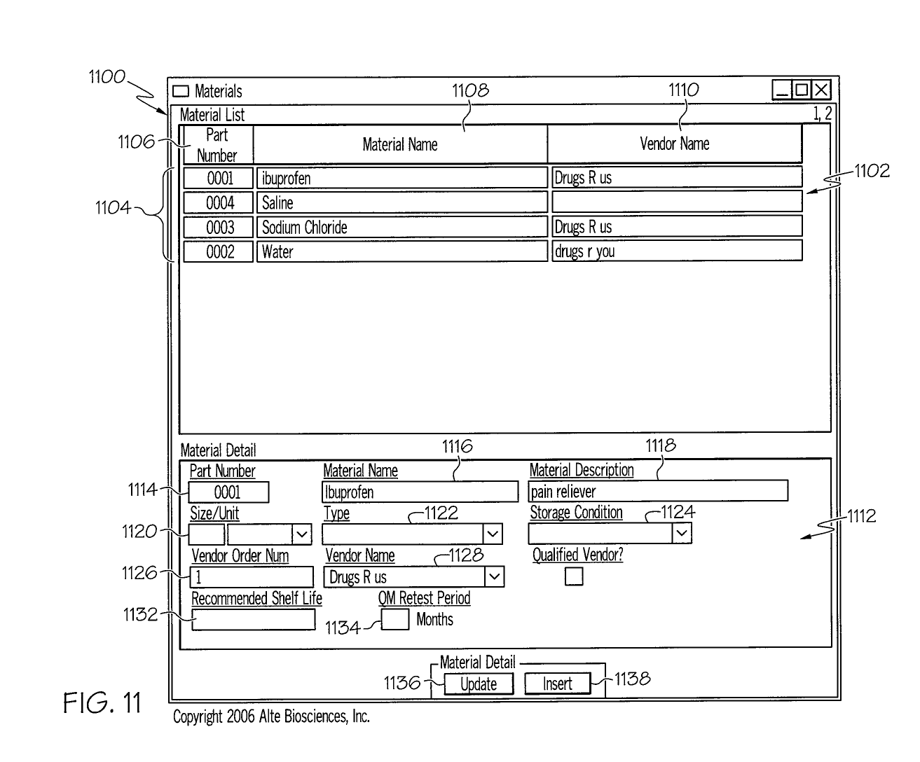

FIG. 11 is an example of a GUI 1100 to enter and record information related to materials associated with a product to be manufactured by the process in accordance with an embodiment of the present invention. The materials GUI 1100 may include two sections and two buttons. A first section 1102 may include a list 1104 of material to manufacture a product. The material list 1104 may include fields for a part number 1106, a material name 1108, a vendor name 1110 and other information that may be appropriately related to the materials needed for the product. The material list 1104 may include every material that is currently in the data source or database associated with the CTM application or manufacturing management module. Clicking on one of the listed materials causes a second section 1112 or materials detail section to become populated. Second section 1112 contains fields for information on the material selected in the first section 1102 or material list. Examples of the fields for entering information related to a material in the material detail section 1112 may include a Part Number 1114, a Material Name 1116, a Material Description 1118, a Size/Unit 1120, a Type 1122, a Storage Condition 1124, a Vendor Order Number 1126, a Vendor Name 1128, a box 1130 to click or check if the vendor is qualified, a Recommended Shelf Life 1132, a Quality Management (QM) Retest Period 1134 and any other field that may be appropriate or needed. All fields in the material detail section 1112 may be editable except for the part number 1114, which may be assigned by the application or manufacturing management module.

An update button 1136 may be used to save any information that is entered or edited in the material detail section 1112. An insert button 1138 may be used to add a new material to the system. Clicking on the insert button 1138 opens the second section 1112 or the materials detail section with all fields being blank. Once the material's information is entered, update button 1136 may be clicked in order to save the information.

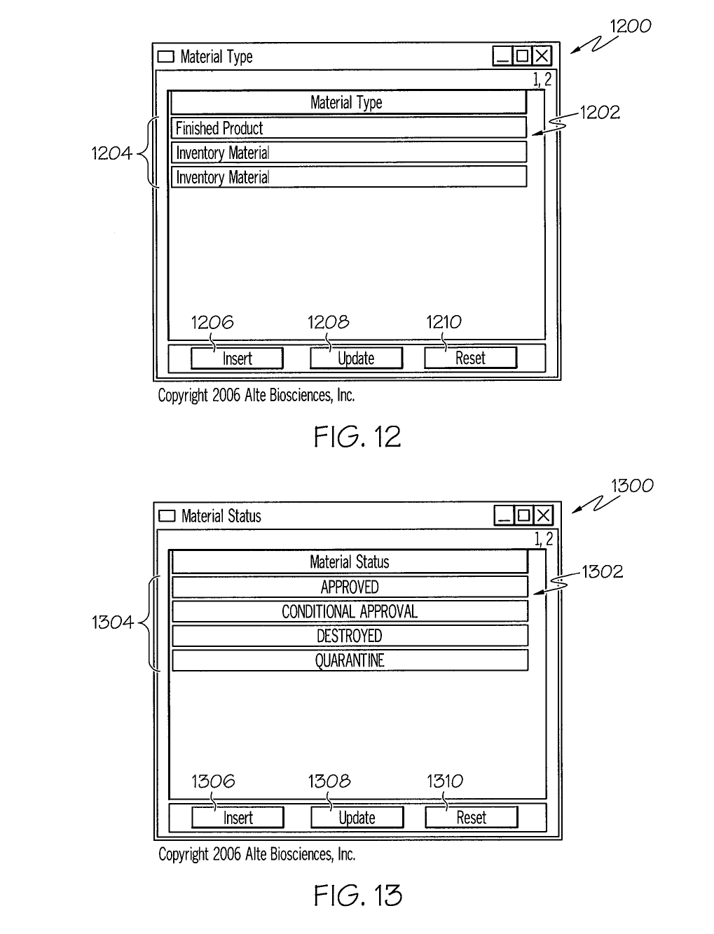

FIG. 12 is an example of a GUI 1200 to enter and record different material types in accordance with an embodiment of the present invention. The materials types GUI 1200 may include one section and three buttons. The one section 1202 may include a material type list 1204, which shows all material types that are currently in the data source associated with the application or module. An insert button 1206 may be used to add a new material type to the system or list. An update button 1208 may be used to save the new material type. Once the material type is entered, update button 1208 may be clicked in order to save the information. A reset button 1210 may be used to cancel and clear any editing done to the material types that have not yet been saved.

FIG. 13 is an example of a GUI 1300 to enter and record different material statuses in accordance with an embodiment of the present invention. The materials status GUI 1300 may include one section and three buttons. The one section 1302 may include a material status list 1304, which shows all material statuses that are currently in the data source associated with the application. An insert button 1306 may be used to add a new material type to the system. An update button 1308 may be used to save the new status. Once the material status is entered, update button 1308 may be clicked in order to save the information. A reset button 1310 may be used to cancel and clear any editing done to the material statuses that have not yet been saved.

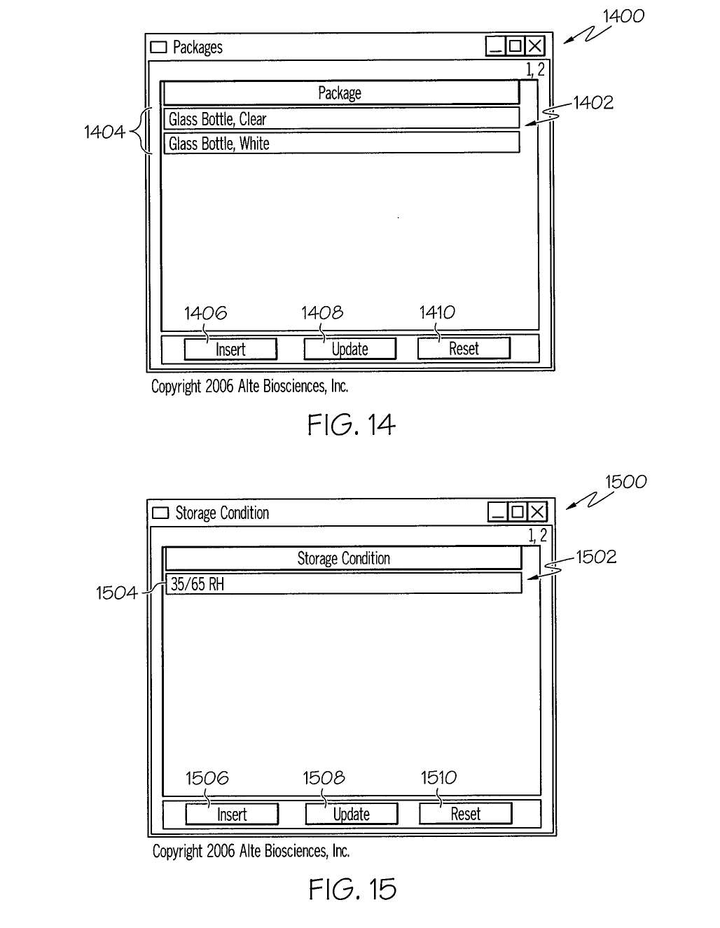

FIG. 14 is an example of a GUI 1400 to enter and record different types of packaging in accordance with an embodiment of the present invention. The packages GUI 1400 may include one section and three buttons. A one section 1402 may include a list 1404 of different types of packaging or packages. The packages list 1404 may show all package types that are currently in the data source associated with the application. An insert button 1406 may be used to add a new package to the system. An update button 1408 may be used to save the new package. Once the package is entered, update button 1408 may be clicked in order to save the information. A reset button 1410 may be used to cancel and clear any editing done to the packages that have not yet been saved.

FIG. 15 is an example of a GUI 1500 to enter and record different storage conditions in accordance with an embodiment of the present invention. The storage conditions GUI 1500 may include one section and three buttons. The one section 1502 may include a storage conditions list 1504, which shows all storage conditions that are currently in the data source associated with the application. An insert button 1506 may be used to add a new storage condition to the system. An update button 1508 may be used to save the new storage condition. Once the storage condition is entered, update button 1508 may be clicked in order to save the information. A reset button 1510 may be used to cancel and clear any editing done to the storage conditions that have not yet been saved.

The system may also include other GUIs for entering information related to materials used to make the product. Examples of other GUIs may include a GUI to enter a unit description associated with a material, a facility to enter a name of facility associated with the material and the like. The GUIs may be similar to those previously described with reference to FIGS. 12-15.

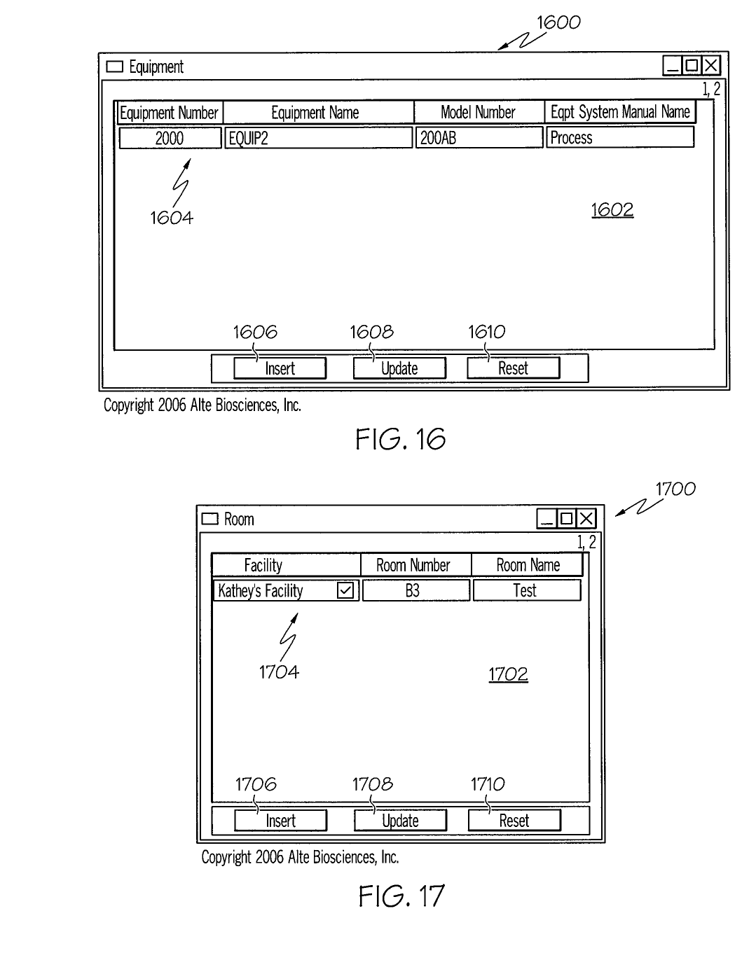

FIG. 16 is an example of a GUI 1600 to enter and record equipment information associated with a manufacturing process in accordance with an embodiment of the present invention. The equipment GUI 1600 may include one section and three buttons. The one section 1602 may include an equipment list 1604, which may list all equipment that is currently in the data source associated with the CTM application or manufacturing management module. An insert button 1606 may be used to add new equipment to the system. An update button 1608 may be used to save the new equipment. Once the equipment is entered, update button 1608 may be clicked in order to save the information. A reset button 1610 may be used to cancel and clear any editing done to the equipment list 1604 that has not yet been saved.

FIG. 17 is an example of a GUI 1700 to enter and record room information associated with managing a manufacturing process in accordance with an embodiment of the present invention. The rooms GUI 1700 may include one section and three buttons. The section 1702 may include a rooms list 1704, which shows all rooms that are currently in the data source associated with the application. An insert button 1706 may be used to add a new room to the system. An update button 1708 may be used to save the new rooms. Once the room is entered, update button 1708 may be clicked in order to save the information. A reset button 1710 may be used to cancel and clear any editing done to the rooms that have not yet been saved.

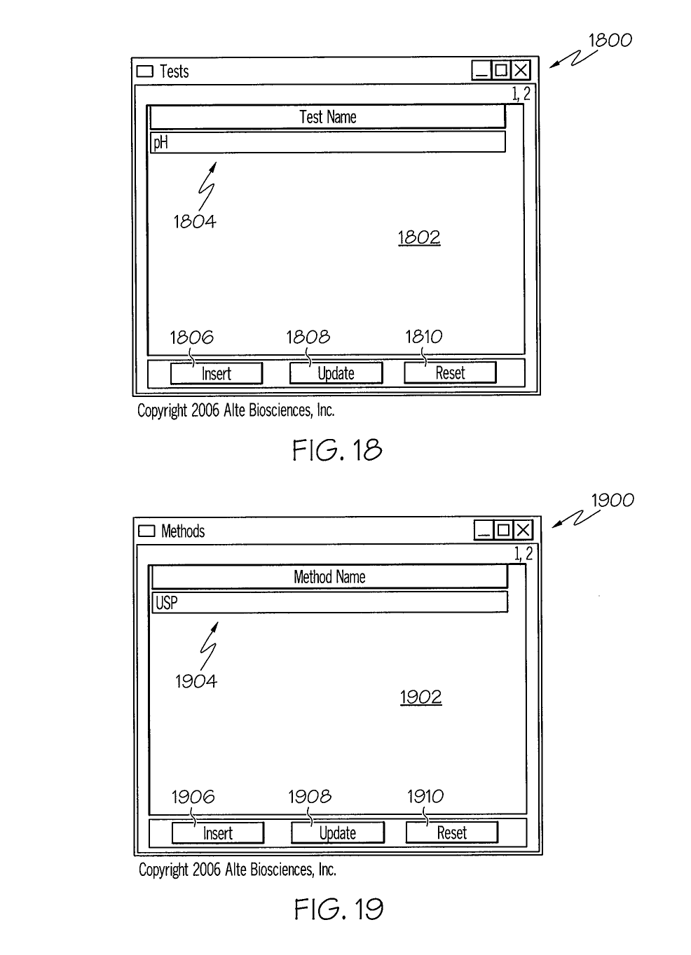

FIG. 18 is an example of a GUI 1800 to enter and record test information or different types of tests associated with managing a manufacturing process in accordance with an embodiment of the present invention. The tests GUI 1800 may include one section and three buttons. The one section 1802 may include a list 1804 of different tests to be performed on a selected material. The tests list 1804 may include all tests that are currently in the data source associated with the CTM application or manufacturing management module. An insert button 1806 may be used to add a new test to the system. An update button 1808 may be used to save the new test. Once the test is entered, update button 1808 may be clicked in order to save the information. A reset button 1810 may be used to cancel and clear any editing done to the tests that have not yet been saved.

FIG. 19 is an example of a GUI 1900 to enter and record method information or different types of tests associated with managing a manufacturing process in accordance with an embodiment of the present invention. The methods GUI 1900 may include one section and three buttons. The one section 1902 may include a list of methods 1904 associated with a selected material. The methods list 1904 may include all methods that are currently in the data source associated with the CTM application or manufacturing management module. An insert button 1906 may be used to add a new method to the system. An update button 1908 may be used to save the new method. Once the method is entered, update button 1908 may be clicked in order to save the information. A reset button 1910 may be used to cancel and clear any editing done to the methods that have not yet been saved.

FIG. 20 is an example of a GUI 2000 to enter a query associated with managing a manufacturing process, such as a clinical trials manufacturing process, in accordance with an embodiment of the present invention. The query mode GUI 2000 may include one section and three buttons. The one section 2000 may include a query selection menu or menus 2002 to specify a query. The menus 2002 may be drop-down type menus. From the drop down menus 2002, the user may select search parameters for the query of interest. Examples of the drop down menus 2002 may be an item name 2004, a vendor name 2006, an item type 2008, a part number 2010 or any other parameter that may be appropriate to conduct a query to search the data source of the system. A retrieve button 2012 may be used to execute the query to return all items that match the specified parameters. A reset button 2014 may be used to cancel and clear any selecting done to the boxes or to clear the current search. A close button 2016 closes the GUI 2000.

The exemplary GUIs illustrated in FIGS. 21 and 22 may be presented as part of the operations associated with block 226 of method 200 of FIG. 2. FIG. 21 is an example of a GUI 2100 to enter and record or log equipment information associated with a manufacturing process in accordance with an embodiment of the present invention. The equipment log GUI 2100 may include two sections and one button. A first section 2102 may include an equipment list 2104. The equipment list 2104 may include fields to enter information related to each piece of equipment associated with manufacturing the product. For example, the equipment list 2104 may include fields for an equipment number 2106, an equipment name 2108, a model number 2110, equipment system manual name 2112 and any other information related to the equipment that may be desired to be logged. The equipment list 2104 may include all equipment that is currently in the data source associated with the CTM application or manufacturing management module. Clicking on a row or a specific piece of equipment in the first section 2102 causes a second section 2106 or equipment log detail section to become populated. Right clicking on a row or on a selected piece of equipment in the first section 2102 allows the user to add a new log entry for the selected equipment. Second section 2107 may contain fields for entering different information related to the selected equipment in the first section 2102. Examples of the different fields or types of information that may be entered may include Equipment Action 2108, Start Date and Time 2110, End Date and Time 2112, Cleaning Agent 2114, Batch Number 2116, Operator Initials 2118, Facility Manager Initials 2120, Approval Date 2122, and a field for comments 2124. Field for any other information that may be deemed appropriate may also be included. All fields in the second section 2106 are editable, except for the equipment number 2126, which may be assigned in another part of the application. An update button 2128 may be used to save any information that is entered or edited in the equipment log detail section 2106.

FIG. 22 is an example of a GUI 2200 to enter and record or log room information associated with a manufacturing process in accordance with an embodiment of the present invention. The room log GUI 2200 may include two sections and one buttons. A first section 2202 may include a room list 2204. The room list 2204 may include fields to enter information related to the room, such as a facility 2206, a room number 2208, a room name 2210 or other information. The room list 2204 may include all rooms that are currently in the data source associated with the CTM application. Clicking on a row the first section 2202 or entry in the room list 2204 causes a second section 2212 or room log detail section, to become populated. Right clicking on a row in the first section 2202 allows the user to add a new log entry for the room. Second section 2212 contains fields for entering information related to the selected room. Examples of types of information that may be entered may include a room action 2214, a log product 2216, a log batch 2218, operator initials 2220, facility manager 2222, and a comments field 2224 for entering any comments. All fields in the room log detail section 2212 may be editable, except for the room number 2226, which may be assigned in another part of the application. An update button 2228 may be used to save any information that is entered or edited in the room log detail section 2212.

The exemplary GUIs illustrated in FIGS. 23 and 24 may be generated and used as part of the operations associated with block 230 of method 200 in FIG. 2. FIG. 23 is an example of a GUI 2300 to enter and record specifications related to materials associated with a product to be made by the manufacturing process in accordance with an embodiment of the present invention. The material specifications GUI 2300 may include two sections and four buttons. A first section 2302 may include a material specifications list 2304. The material specification list 2304 may include fields for entering information related to a material, such as a specification number 2306, an item name 2308, aversion number 2310 and any other information about a material that may be needed. The material specification list 2304 may include all materials that are currently in the data source associated with the CMT application or manufacturing management module. Clicking on a row or material in the specification list 2304 populates a second section 2312 or material specifications detail section. Second section 2312 shows the specification details for the select material in the specification list 2304. The material specification detail section 2312 may include fields for entering detail information related to the material selected in the specification list 2304 in the first section 2302. Examples of the fields or types of different information may include a specification number 2314, a version 2316, a sample quantity 2318, a unit 2320, a sample instruction field 2322 to enter sample instructions, a sample container field 2324, an item name field 2326, or other information related to specifying a material.

The material specification GUI 2300 may also include a button 2328 labeled “Safety Instruction” or other appropriate label that may be activated or clicked on to view any safety instructions that may be associated with a selected material. The GUI 2300 may also include check boxes 2330 and 2332, respectively, to select if a project manager (PM) and quality assurance (QA) approval is required. Approval may be provided via electronic identification verification. A test button 2334 may be operated to present any tests associated with the specification. The tests button 2334 may be used to add tests to a specification, but only before it has been approved by PM or QA personnel. An insert button 2336 may be used to add a new specification to the system. Clicking on insert button 2336 may open the specification detail section 2312 with all fields being blank. A save button 2338 may be used to save any entered or edited information.

FIG. 24 is an example of a GUI 2400 to enter and record specifications related to a material specification test review in accordance with an embodiment of the present invention. The materials test review GUI 2400 may include two sections and three buttons. A first section 2402 may include a specifications list 2404. The specification list 2404 may include fields for information related to a specification, such as a specification number 2406, an item name 2408, a version number 2410 and any other information relative to a specification that may be needed or appropriate. Clicking on a row or specification in the specification list 2404 populates a second section 2412 or specification test detail section. Second section 2412 may list the tests assigned to a select specification in the specification list 2404. A view button 2414 may be used to view the printable format of the specifications test. A print button 2416 may be used to print a copy of the test for the selected specification. A close button 2418 may be used to close the print friendly window when it has been opened with view button 2414.

FIG. 25 is an example of a GUI 2500 to enter and record information related to a Build Requisition or elements needed to make a product in accordance with an embodiment of the present invention. The build requisitions GUI 2500 may include two sections and four buttons. A first section 2502 may be defined as an available for requisition section, which shows material specifications that are in the system that can be added to a requisition. A second section 2504 may be defined as the requisition items section. The requisition items section 2504 may contain a list of all material specifications to be ordered on the requisition being created, and allows one to request an MSDS (Material Safety Data Sheet) 2506 and/or a C of A (Certificate of Analysis) 2508 as part of the requisition/order. An “Add to Requisition” feature 2510 may be used to add a material specification from the available list 2502 to the requisition. A “Remove from Requisition” feature 2512 may be used to remove a selected item from the requisition. An update requisition button 2514 may be used to save the current working requisition. A complete requisition button 2516 may be used to prompt a requisition review process (see the GUI of FIG. 26) once the requisition has been saved.

FIG. 26 is an example of a GUI 2600 of an exemplary Requisition Review form associated with a manufacturing process in accordance with an embodiment of the present invention. The requisition review GUI 2600 may include three sections and three buttons. A first section 2602 may include a completed requisitions list 2604, which shows a list of all requisitions that have been completed. A second section 2606 may include a list of requisitions that are available for review/printing. A third section 2608 may be defined as a requisition header section, which contains the information that will be included in the header area of a printed requisition. An update header button 2610 may be used to save any information that is entered or edited in the requisition header section 2608. A view button 2612 may be used to view a printable version of a selected requisition. A print button 2614 may be used to print the current requisition to a printer.

The exemplary GUIs of FIGS. 27 through 30 may be generated and used as a part of the operations associated with block 238 of method 200 of FIG. 2. FIG. 27 is an example of a GUI 2700 of an exemplary an Inventory Receipt form associated with a manufacturing process in accordance with an embodiment of the present invention. The inventory receipt form or GUI 2700 may include two sections and two buttons. A first section 2702 may define a requisition receipt section. This area allows a user to view and update the status of requisitions as they are received. A second section 2704 is a requisitions list, which is a list of completed and printed requisitions. Selecting one of these requisitions allows the user to view the requisitions information in the first section 2702. An update button 2706 may be used to save any information that is entered or edited in the first section 2702 or requisition receipt section. A reset button 2708 may be used to cancel and clear any editing in the requisition receipt section. Once clicked, reset button 2708 clears the window, not saving any changes that have been made.

FIG. 28 is an example of a GUI 2800 of an exemplary Inventory Status form associated with a manufacturing process in accordance with an embodiment of the present invention. The inventory status form 2800 or GUI may include two sections and one button. A first section 2802 may be an inventory status section, which allows the user to view status of received requisitions. Clicking on one of the receipt numbers populates a second section 2804 or inventory status detail section. Second section 2804 shows the details of the selected receipt. Users can modify the details of the receipt in this section. If details of the receipt are modified after approval, the status 2806 changes from approved to “xxxx” until the receipt is approved again. Approval requires electronic identification verification. An update button 2808 may be used to save any information that is entered or edited in second section 2804 or inventory status detail section.

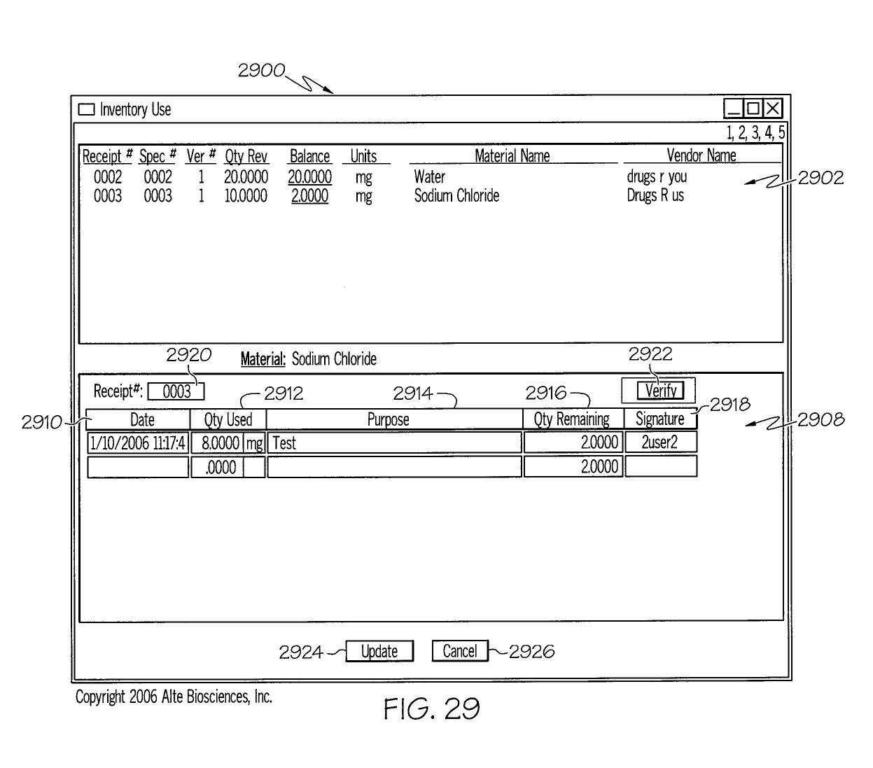

FIG. 29 is an example of a GUI 2900 of an exemplary Inventory Use form associated with a manufacturing process in accordance with an embodiment of the present invention. The inventory usages form 2900 or GUI may include two sections and three buttons. A first section 2902 may include an inventory usage list 2904, which shows a non-depleted inventory that is currently available in the system. An individual receipt 2906 may be clicked-on to view the details of the item or material associated with the receipt 2906. A second section 2908 or inventory usage detail section may be populated in response to clicking-on the receipt 2906. The inventory usage detail section 2908 may show all previous usages of the item or material and may allow the user to enter more uses. The second section or inventory usage detail section 2908 may include information about the material selected, such as date used 2910, quantity used 2912, purpose 2914, quantity remaining 2916, and a signature 2918 or designation of the individual that entered the information. All fields of second section 2908 may be editable, except for a receipt # field 2920, which may be set elsewhere in the application. A verify button 2922 may be used to electronically sign (verify) a new use for the material. Clicking on the verify button 2922 prompts the user to enter his/her user name and password. An update button 2924 may be used to save any information that is entered or edited in the inventory usage detail section 2908. A cancel button 2926 may be used to cancel and clear any editing in the inventory usage section 2908. Once clicked, cancel button 2926 clears the window, not saving any changes that have been made.

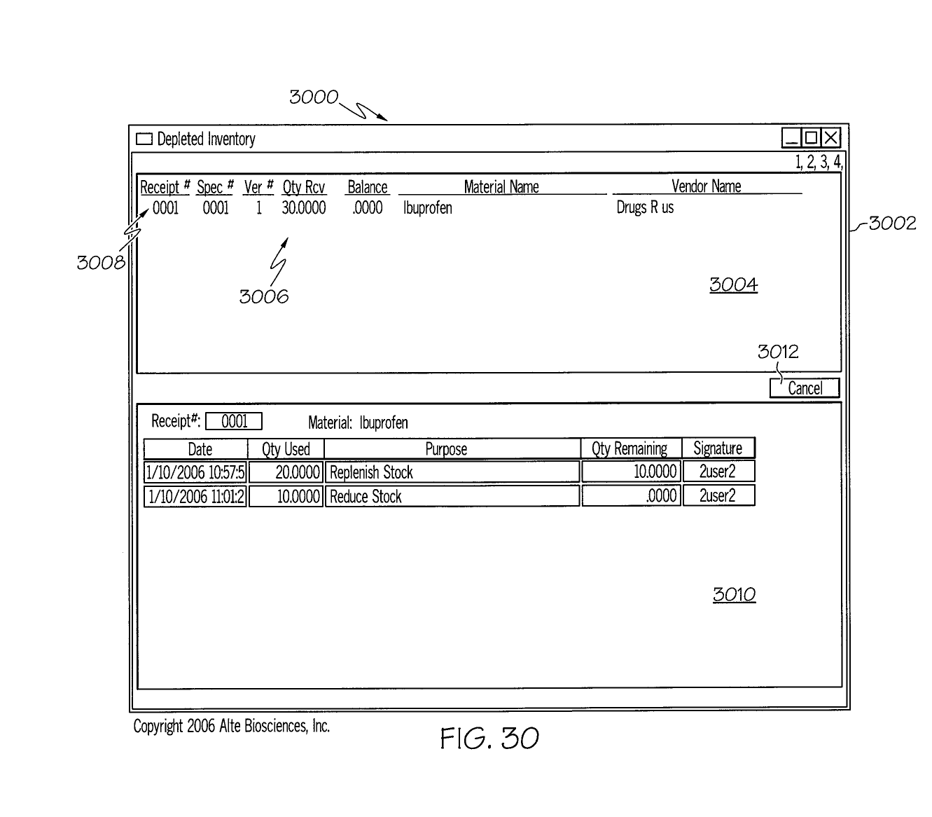

FIG. 30 is an example of a GUI 3000 of an exemplary Inventory Depleted form 3002 associated with a manufacturing process in accordance with an embodiment of the present invention. The depleted inventory form 3002 may include two sections and one button. A first section 3004 may include a depleted inventory list 3006. A row or receipt number 3008 may be clicked-on to present details associated with a material corresponding to the row or receipt number 3008. A second section 3010 or depleted inventory details section may be presented or populated in response to clicking-on or selecting the row or receipt number 3008. The depleted inventory details section 3010 may show a history of the use of the selected material. A cancel button 3012 may be used to clear the depleted inventory detail section 3010.

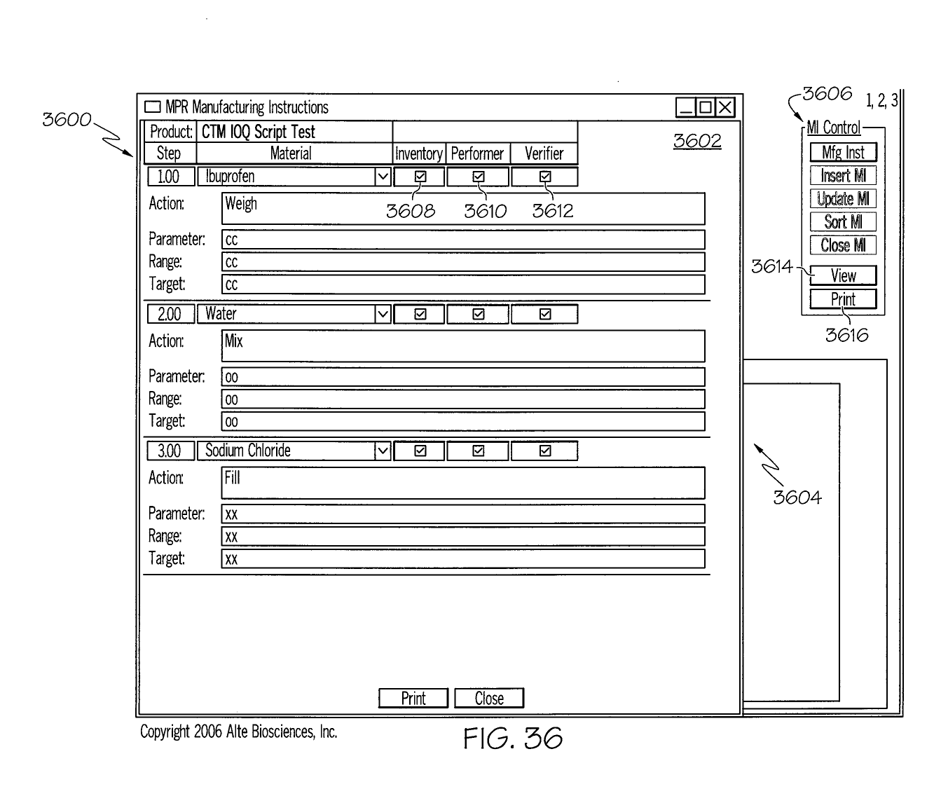

The exemplary GUIs in FIGS. 31 through 38 may be generated and used as a result of operations associated with block 242 of method 200 of FIG. 2. FIG. 31 is an example of a GUI 3100 of an exemplary Master Production Record (MPR) 3102 associated with a manufacturing process in accordance with an embodiment of the present invention. The MPR 3102 or GUI 3100 may include four sections and one button. A first section 3104 or product section may list a client product code 3106, a MPR ID number 3108, and MPR version 3110 of all products that are currently in the data source associated with the CTM application or manufacturing management module. A second section 3112 or master record copy section may be used to copy an existing MPR into an empty product. A third section 3114 may define a manufacturing instructions controls section which may include buttons for defining, inserting, updating, and sorting manufacturing instructions. As an example, clicking on a “Mfg Inst” button 3116 opens a manufacturing instructions GUI, such as the MPR manufacturing instructions GUI 3600 of FIG. 36.

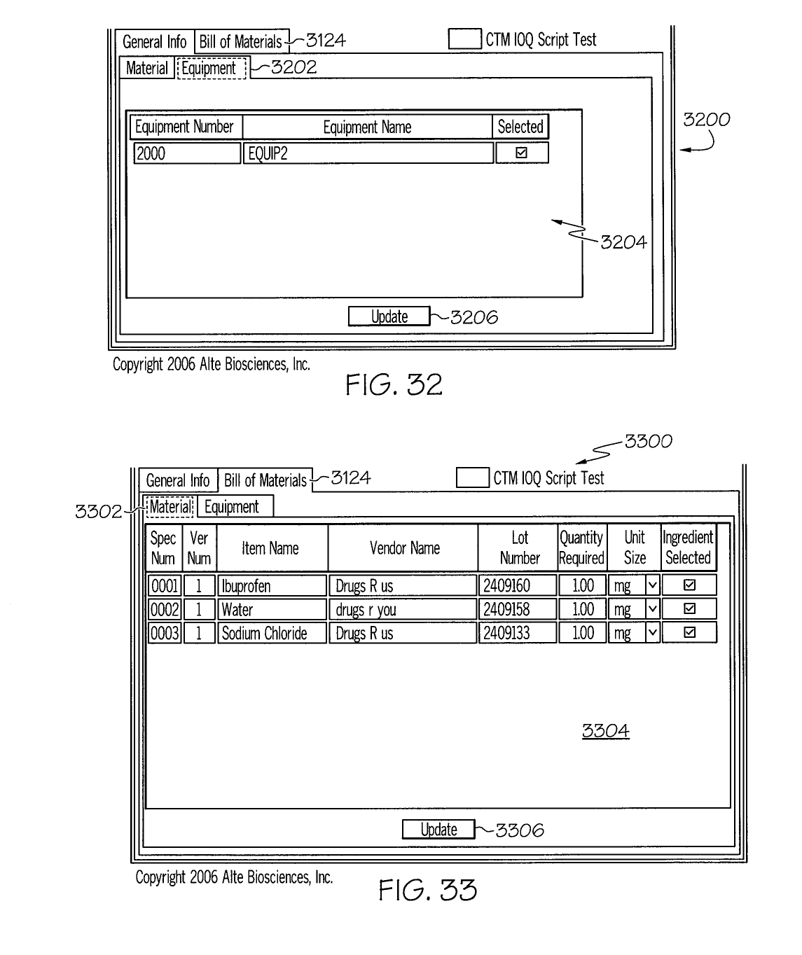

A fourth section 3118 may include a set of tabs 3120 for presenting different sets of information related to manufacturing instructions. The tabs 3120 may be selected by a user to display the different sets of information. The tabs 3120 may include a general information tab 3122, a bill of materials tab 3124, a cover page tab 3126, a MPR approvals tab 3128, and an in process test tab 3130. A fifth section 3132 may contain details of the currently selected tab or tabs 3120. FIG. 31 illustrates an example of the general information tab 3122 and the cover page tab 3126 being active or selected. An example of the information that may be contained in the general information and cover page tabs 3122 and 3126 is displayed in the section 3132 of FIG. 31. An update button 3134 may be used to save any changes to the cover page information. More details of the information that may be displayed by use of tab set 3120 of the MPR GUI 3100 are shown in FIGS. 32, 33, 34 and 35 and will be described with reference thereto.

FIG. 32 is an example GUI 3200 responsive to the Bill of Materials tab 3124 and an Equipment tab 3202 of the MPR 3102 (FIG. 31) being active or selected in accordance with an embodiment of the present invention. The GUI 3200 displayed corresponds to the information section 3132 of FIG. 31. The GUI 3200 may be referred to as an equipment tab GUI. The equipment tab GUI 3200 may include one section and one button. The one section 3204 may include an equipment section, which shows a list of all equipment to be used in the product or to manufacture the product. Examples of possible fields that may be included in the equipment tab GUI 3200 are illustrated in FIG. 32. An update button 3206 may be used to save any changes made to the information in the GUI 3200.

FIG. 33 is an example of a GUI 3300 responsive to the Bill of Materials tab 3124 and the Material tab 3302 of the MPR 3102 being selected in accordance with an embodiment of the present invention. The GUI 3300 may be referred to as a material tab GUI. The material tab GUI 3300 may include one section and one button. The one section 3304 may define a material section, which shows a list of all material available for use in the product. Examples of the fields that may be included in the material tab GUI 3300 are illustrated in FIG. 33. An update button 3306 may be used to save any changes made to the GUI 3300.

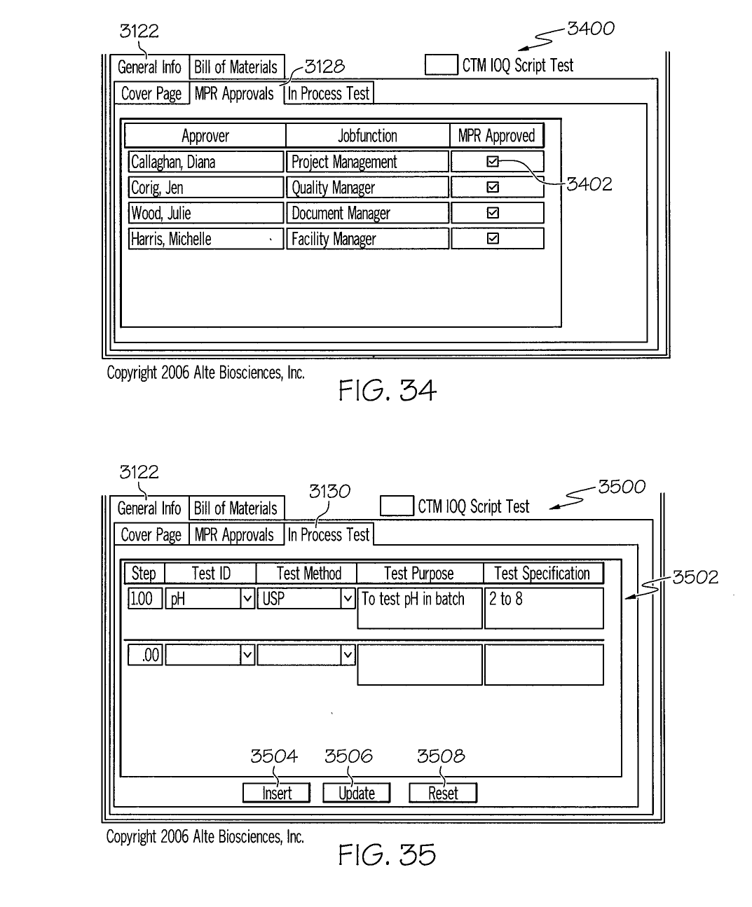

FIG. 34 is an example of a GUI 3400 responsive to the General Info tab 3122 and the MPR Approvals tab 3128 of a MPR 3102 (FIG. 31) being selected in accordance with an embodiment of the present invention. The GUI 3400 may be referred to as a MPR approvals tab GUI. The GUI 3400 may be referred to as a MPR approvals tab. The MPR approvals tab GUI 3400 may list individuals that are authorized to approve a MPR. Examples of the fields that may be included in a MPR approvals tab GUI 3400 are illustrated in FIG. 34. A MPR Approved check box 3402 may be associated with each person. Clicking on the MPR Approved check box 3402 may prompt a user to verify his/her credentials for approving the MPR.

FIG. 35 is an example of a GUI 3500 responsive to the General Info tab 3122 and the In Process Test tab 3130 of a MPR 3102 being selected in accordance with an embodiment of the present invention. The GUI 3500 may be referred to as an in process test tab GUI. The in process test tab GUI 3500 may include one section and three buttons. The one section 3502 may define an in process test section, which shows the current in process tests. Examples of the fields that may be included in the in process test tab GUI 3500 are illustrated in FIG. 35. An insert button 3504 may be used to add a new in process test. An update button 3506 may be used to save any changes made to the section 3502. A reset button 3508 may be used to clear any unsaved changes that have been made.

FIG. 36 is an example of a GUI 3600 of an exemplary MPR Manufacturing Instructions form 3602 in accordance with an embodiment of the present invention. The GUI 3600 may be referred to as a manufacturing instructions GUI. The manufacturing instructions GUI 3600 or form 3602 may include one section and two buttons. The one section 3604 may define a manufacturing instructions section, which lists the instructions for the MPR. The manufacturing instructions GUI 3500 may include a set of control buttons 3606 or similar controls. Using the set of controls 3606, a user may insert, update, sort, and close the manufacturing instructions.

The manufacturing instructions GUI 3600 may also include check boxes for inventory 3608, performer 3610 and verifier 3612. Checking the inventory, performer, and/or verifier check box 3608, 3610 or 3612 requires actions associated with those areas to be performed during a batch production. A view button 3614 may be used to see a printer friendly version of the MPR. A print button 3616 may be used to print the MPR.

FIG. 37 is an example of a GUI 3700 of an exemplary Batch Production Record (BPR) associated with a manufacturing process in accordance with an embodiment of the present invention. The GUI 3700 may be referred to as a define BPR GUI 3700. The define BPR GUI 3700 may be similar to the MPR GUI described with reference to FIGS. 31-36. The define BPR GUI 3700 may include three sections and one button. A first section 3702 may define a product section, which may list a client product code 3704, a MPR ID number 3706, and a MPR version 3708 of all products in the current data source associated with the CTM application or manufacturing management module. A second section 3710 may define a batch extensions section, which may list all batch extensions for the selected product. A tab set 3712 may be used to select between, for example, a general information tab 3714, a bill of materials tab 3716, a cover page tab 3718, an executed BPR approvals tab 3720, and an in process test tab 3722. FIG. 37 shows an example of the general information tab 3714 and the cover page tab 3718 being selected to display the cover page information in a fifth section 3724. The different tabs 3712 may be selected similar to that described with respect to the MPR GUI 3100 of FIG. 31 to present GUIs similar to the GUIs in FIGS. 32-36 and as previously described, except in association with a batch production record.

A view button 3726 may be used to view a printer-friendly version of the BPR.

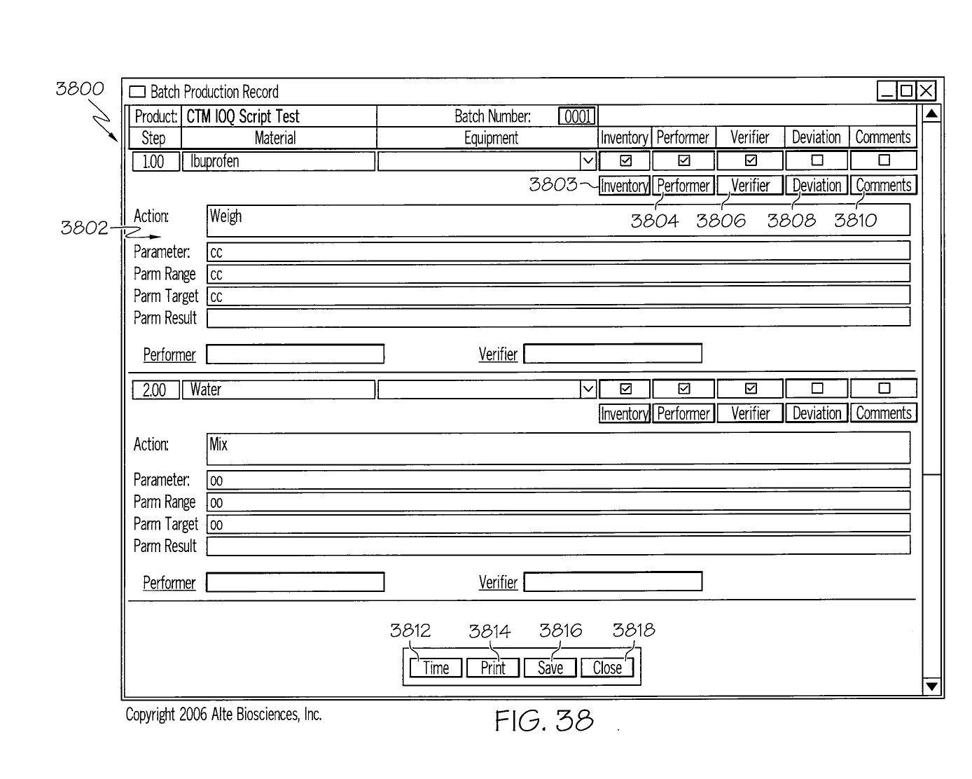

FIG. 38 is an example of a GUI 3800 of an exemplary Batch Production Record (BPR) associated with a manufacturing process in accordance with an embodiment of the present invention. The GUI 3800 may be referred to as a BPR GUI. The batch production record GUI 3800 may include one section and nine buttons. The one section 3802 may define a batch step section, which displays the information for each step of the production and allows the results for the step to be entered. An inventory button 3802 may be a check to make sure that the inventory has been updated on required steps. A performer button 3804 may be a check to sign off when performer verification is required. A verifier button 3806 may be a check to sign off when a verifier is required. A deviation button 3808 may be used to enter any deviations that occurred during this step. A comments button 3810 may be used to enter any comments or notes for this step. A time button 3812 may be used to bring up the timer interface (not shown). A print button 3814 is used to print out the batch manufacturing steps. A save button 3816 may be used to save any changes that have been made to the batch production record. A close button 3818 may be used to close the batch production record interface.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for developing and managing a manufacturing process, comprising:
presenting a graphical user interface to define a project for developing and managing the manufacturing process for a product;
storing the data entered to define the project in a database;
presenting a graphical user interface to at least one process development participant for entering data related to developing and managing the manufacturing process;
storing the data related to developing and managing the manufacturing process in the database; and
presenting selected data related to developing and managing the manufacturing process.

2. The method of claim 1, further comprising:
presenting a graphical user interface to enter personnel information for the project;
presenting a graphical user interface for making personnel assignments for the project; and
presenting a graphical user interface for entering information related to a project sponsor.

3. The method of claim 1, further comprising presenting a graphical user interface to enter a list of materials for manufacturing the product and to enter information related to each material in the list of materials.

4. The method of claim 1, further comprising providing a quality assurance system associated with the manufacturing process.

5. The method of claim 1, further comprising allowing specification of any equipment for the project.

6. The method of claim 1, further comprising:
allowing specification of each material for the product; and
including a final quality assurance review and approval.

7. The method of claim of claim 6, further comprising:
permitting specification of any tests related to each material; and
allowing review of material specification tests.

8. The method of claim 1, further comprising:
presenting an inventory status;
presenting an inventory use; and
presenting an indication of inventory depletion.

9. The method of claim 1, further comprising:
allowing a master production record to be defined; and
allowing the master production record to be reviewed and approved by a quality assurance group.

10. The method of claim 9, wherein allowing a master production record to be defined comprises:
presenting a group of fields in a graphical user interface for entering general information related to the product;
presenting a group of fields in the graphical user interface or another graphical user interface for specifying a bill of materials;
presenting at least one field in the graphical user interface or another graphical user interface for entering information related to approval for the master production record including a quality assurance approval;
presenting a field in the graphical user interface or another graphical user interface for specifying at least one test associated with the materials; and
permitting specification of manufacturing instruction.

11. The method of claim 1, further comprising allowing a batch production record to be defined.

12. The method of claim 11, wherein allowing a batch production record to be defined comprises:
presenting a group of fields in a graphical user interface for entering general information related to the product;
presenting a group of fields in the graphical user interface or another graphical user interface for specifying a bill of materials;
presenting at least one field in the graphical user interface or another graphical user interface for entering information related to approval for the batch production record including quality assurance approval; and
presenting a filed in the graphical user interface or another graphical user interface for specifying at least one test associated with the batch.

13. The method of claim 1, further comprising:
permitting ordering and tracking of materials for the product;
permitting management and tracking of inventory; and
permitting manipulation and reporting of manufacturing process data.

14. The method of claim 1, further comprising enabling a plurality of project participants to be geographically dispersed.

15. The method of claim 1 wherein developing and managing the manufacturing process comprises developing and managing a manufacturing process for a drug product or active pharmaceutical ingredient.

16. A method for developing and managing a manufacturing process, comprising:
enabling a project to be defined for developing and managing the manufacturing process for a product or active pharmaceutical ingredient;
storing the data entered to define the project in a database;
enabling a plurality of geographically disperse process development participants to enter data related to developing and managing the manufacturing process and quality information;
storing the data related to developing and managing the manufacturing process and quality information in the database; and
presenting selected data related to developing and managing the manufacturing process or quality information in response to a query.

17. The method of claim 16, further comprising at least one of:
permitting preformulation experimental data to be entered and stored in a database;
permitting one of formulation compositions and experimental data to be entered and stored in the database;
permitting analytical method descriptions and validation report data to be entered and stored in the database;
permitting data to satisfy regulatory or quality requirements to be entered and stored.

18. The method of claim 16, further comprising:
permitting production data to be entered and stored; and
permitting equipment specifications and equipment setting to be entered and stored.

19. A system for developing and managing a manufacturing process, comprising:
a processor; and
a manufacturing management module operable on the processor, wherein the manufacturing management module is capable of presenting a graphical user interface to define a project for developing and managing the manufacturing process for a product; presenting a graphical user interface to at least one process development participant for entering data related to developing and managing the manufacturing process; and presenting selected data related to developing and managing the manufacturing process.

20. The system of claim 19, further comprising means for enabling a plurality of project participants to be geographically dispersed.

21. The system of claim 19, wherein the project comprises developing and managing the manufacturing process and a quality assurance system associated with the manufacturing process.

22. The system of claim 19, further comprising:
means for entering a list of materials to manufacture the product and to enter information related to each material in the list of materials;
means to allow specification of any equipment for the project; and
means for specifying any test related to manufacturing the product.

23. A computer program product for developing and managing a manufacturing process and a quality assurance system, the computer program product comprising:
a computer usable medium having computer usable program code embodied therein, the computer usable medium comprising:
computer usable program code configured to enable a project to be defined for developing and managing the manufacturing process and quality assurance system for a product;
computer usable program code configured to store the data entered to define the project in a database;
computer usable program code configured to enable a plurality of geographically disperse process development participants to enter data related to developing and managing the manufacturing process or quality assurance system;
computer usable program code configured to store the data related to developing and managing the manufacturing process in the database; and
computer usable program code configured to present selected data related to developing and managing the manufacturing process and quality assurance system in response to a query.

24. The computer program product of claim 23, wherein the computer usable medium further comprises:
computer usable program code configured to allow entering a list of materials to manufacture the product and to enter information related to each material in the list of materials;
computer usable program code configured to allow specification of any equipment for the project; and
computer usable program code configured to allow specifying any test related to manufacturing the product.

25. The computer program product of claim 23, wherein the computer usable medium further comprises:
computer usable program code configured to permit inventory tracking and control;
computer usable program code configured to permit production data to be entered and stored; and
computer usable program code configured to permit equipment specifications and equipment setting to be entered and stored.
